(19) United States
(12) Patent Application Publication
(10) Pub. No.: US 2016/0086236 A1
(43) Pub. Date: Mar. 24, 2016

(54) Improvements in Systems, Methods and Devices for Processing Transactions

(71) Applicant: JVE SOLUTIONS LIMITED, Hove (GB)

(72) Inventor: Jeremy Jack Samuel Viner, Barnet (GB)

(73) Assignee: JVE SOLUTIONS LIMITED, Hove (GB)

(21) Appl. No.: 14/785,223

(22) PCT Filed: Apr. 17, 2014
(86) PCT No.: PCT/GB2014/051219

§ 371 Date: Oct. 16, 2015

(30) Foreign Application Priority Data
Apr. 18, 2013 (GB) 1307061.0

(51) Int. Cl. G06Q 30/06; G06K 9/00; G06Q 10/08

(52) U.S. Cl. CPC G06Q 30/0601; G06Q 10/08355; G06K 9/00295; G06K 9/00261

(57) ABSTRACT

A system for ordering a product or service from a product or service provider, utilising a mobile device, comprises a processor; memory configured to store customer preference information specifying one or more products or services; means for determining a location of the mobile device; and a transmission subsystem for transmitting or triggering an order for one or more products or services specified in the customer preference information to a base station located at the product or service provider. The processor is configured to cause the transmission subsystem to transmit or trigger an order for one or more products or services based upon the determined location of the mobile device. Associated systems, devices and methods are also disclosed.

### FIELD

The present invention relates to improvements in systems, methods and devices for processing transactions. In particular, the invention relates to systems, methods and devices for acquiring, ordering and collecting a product or service from a product or service provider. In a specific implementation, the invention relates to ordering a product or service based on a determined location of a mobile device. The invention also relates to systems and methods for identifying an acquirer of a product or service, and systems and methods for authenticating an acquirer of a product or service.

### BACKGROUND

The conventional shopping experience for a consumer (henceforth ‘acquirer’) wishing to purchase one or products or services (henceforth ‘goods’) can be summarised as follows. An acquirer makes a conscious decision to purchase the goods; researches suppliers of such goods and visits one or more of the suppliers' shops; queues with likeminded acquirers to purchase said goods from the shopkeeper (henceforth ‘merchant’ or simply ‘supplier’) to await processing of a transaction to obtain possession of the goods; pays for the goods using cash, debit or credit card (henceforth ‘payment card’), for example, and then leaves the shop.

An example of the conventional shopping experience is the purchase of a cup of coffee from a coffee shop by a commuter on their way to work. The commuter becomes aware of their desire for a cup of coffee and decides to purchase one. After researching coffee shops in their local area, the commuter selects a coffee shop which is closest to his or her workplace and enters the shop, joining the back of the queue to wait to place an order with the barista. When the commuter reaches the front of the queue he or she places the order, makes payment using cash or payment card and receives a cup of coffee. The commuter then leaves the coffee shop and continues to work.

This conventional experience is replicated by acquirers worldwide in respect of many different kinds of suppliers for many different kinds of goods.

Of course, in recent years the conventional shopping experience has evolved. In particular, the advent of shopping using the internet has meant that prospective acquirers need not always visit a merchant to make a purchase. As with the ‘mail-order’ shopping model which preceded it, internet shopping has made the lives of prospective acquirers easier, because it replaces the often considerable effort expended in visiting a merchant with delivery to the acquirer.

However, mail-order and internet shopping will never completely replace the conventional model for two reasons. Firstly, acquirers often wish to obtain a product or service more quickly than delivery will allow, or inspect the goods in the presence of a merchant. Secondly, certain goods are not appropriate for delivery; a cup of coffee being just one example.

Other more sophisticated models have been developed to improve the conventional model. For instance, US patent publication no. U.S. Pat. No. 7,376,584 discloses a system for facilitating the purchase of, in particular, fast food from a ‘drive-through’ merchant. In that document, a system is described whereby a motorist is prompted to satisfy his or her hunger by noticing an advert for a fast food restaurant. The advert offers a facility to place an order with the merchant ‘wirelessly’, by transmitting the order using a mobile device in communication with the merchant via one or more wireless base stations. The merchant receives the order and may begin preparing the order before the motorist arrives at the restaurant. Upon arrival, the motorist need only pay the merchant and collect the pre-prepared goods. Hence, the more sophisticated model is able to improve an acquirer's experience by removing the need to wait in a queue to place an order for goods.

The system disclosed in U.S. Pat. No. 7,376,584 has certain drawbacks, however, including the need to prompt the motorist to place an order by use of an advert, and the requirement of the motorist to instigate the order. In many scenarios (for example, in the purchase of a cup of coffee) these drawbacks would prevent a prospective acquirer from abandoning the conventional shopping model and instigating an order for a cup of coffee on a mobile device for the sake of queuing. Many prospective acquirers would consider the effort of instigating an order for a cup of coffee on a mobile device to outweigh the inconvenience of queuing to place an order at the merchant.

Hence, a need exists for improved systems, methods and devices for ordering a product or service from a product or service provider.

Other techniques have been developed for making the lives of prospective acquirers easier when purchasing goods or services. For instance, various systems have been established for identifying the closest or most convenient merchants for a prospective acquirer of goods. One such system is described in US patent publication no. U.S. Pat. No. 8,190,135, which discloses the use of location information to filter a list of contacts and sort them in terms of proximity. In that document, an example is given of arranging a list of service providers based on attributes including availability, expertise, and proximity to the system user. US patent application publication no. US2002/0077876 discloses a system for allocating a location-related order′ to one of a number of mobile agents. For instance, a passenger at a particular location who is in need of a taxi may utilise the system disclosed in that document to direct his or her order for a taxi, along with location information, to the closest taxi.

Neither of the aforementioned systems, however, addresses the need described above.

Another key area in which advances have been made is that of processing the transaction, and more specifically processing payment for the goods. It will be appreciated that considerable time is spent exchanging cash or processing a card transaction, and in circumstances where a merchant is particularly busy (i.e. the queue is long), this can cause frustration amongst prospective acquirers and, ultimately, loss of sales.

Recently, the use of RFID chips in payment cards, often supplemented with a PIN, has reduced the time required to process a payment. However, with such improvements in convenience comes a reduction in the security of a transaction. For example, the removal of the requirement for a PIN means that any person can use the card to process a transaction.

This problem has been addressed, to some extent, by making use of biometric information about the acquirer. The biometric information of the owner of a payment card or bank account is registered, stored and made accessible to merchants for processing payments. When an acquirer presents a payment card associated with registered biometric information, the acquirer submits his biometric information to be checked by the merchant against the registered information. Payment is processed only if a match is made between the submitted information and the registered information.

Systems in which biometric information is given to supplement or even replace payment using a payment card are described in US patent publication no. 7506818 and US patent application publication no. US2007/0288320.

The use of biometric data to facilitate payment represents an improvement over the convention methods of payment descried above in terms of speed, and an improvement over the use of RFID alone in terms of security. Nevertheless, needs remain for improved systems and methods for identifying and authenticating an acquirer of a product or service from a product or service provider.

### SUMMARY OF INVENTION

To address the above needs, the present invention provides, in a first aspect, a system for ordering a product or service from a product or service provider, utilising a mobile device, comprising: a processor; memory configured to store customer preference information specifying one or more products or services; means for determining a location of the mobile device; and a transmission subsystem for transmitting or triggering an order for one or more products or services specified in the customer preference information to a base station located at the product or service provider; wherein: the processor is configured to cause the transmission subsystem to transmit or trigger an order for one or more products or services based upon the determined location of the mobile device.

By ‘products or services’ it is meant any good which may be acquired from a supplier (that is, a product or service provider) by an acquirer. The acquisition may be a purchase, loan, gift or any other financial or legal transaction undertaken between the supplier and the acquirer.

By ‘customer preference information’ it is meant any given by the acquirer which may be used to determine the content and context of the transaction which is to take place. For instance, the preference may be for one or more products or services; one or more product or service providers; one or more values of consideration (that is; offer or sale prices) from the acquirer; or, as described more fully below, one or more periods of time or geographical regions in which a transaction is to take place.

By ‘acquirer’ it is meant any person engaging in the acquisition of goods from the supplier, however it is acquired. A customer is an acquirer, and use of ‘customer’ in this description shall be interpreted accordingly.

By triggering or transmitting an order based upon a determined location of the acquirer using his or her mobile device, the present invention improves the ease with which an acquirer may place an order and thus minimises the effort which an acquirer must make in order to carry out a transaction.

Transmission of an order may take place if, for example, the order was to be instigated from the mobile device itself. For example, the data necessary to compile the order may be stored locally on the mobile device, and then transmitted by the transmission subsystem (on the mobile device) to the server or base station at the appropriate time.

On the other hand, triggering of an order may take place if, for example, the order was to be instigated from the server rather than the mobile device. For example, the data necessary to compile the order may be stored remotely on the server, and then transmitted by the transmission subsystem (at the server) to base station at the appropriate time. In that instance, a signal indicating that the order should be transmitted may be sent from the mobile device to the server to trigger transmission of the order.

The memory may be further configured to store catalogue information specifying one or more products or services provided by the product or service provider. Catalogue information may enable an acquirer to review and select one or more products or services from one or more providers which the acquirer may at some point in time or at some location wish to acquire. The selected products or services and/or the selected providers derived from the catalogue information may be specified in the customer preference information, and either stored on the mobile device or on the server. The catalogue information may include the price and description of products and services offered by the supplier.

A clock may be provided for determining the time. The processor may be further configured to cause the transmission subsystem to transmit or trigger an order for one or more products or services based upon the determined time.

Thus, an acquirer may instigate an order for a product or service at a particular time of day. For instance, an order for a coffee may be transmitted or triggered when the acquirer arrives at a particular location (such as within a certain radius of a coffee shop) at 07:30 AM.

The customer preference information may specify one or more periods of time. The processor may be further configured to cause the cause the transmission subsystem to transmit or trigger an order for one or more products or services only during the one or more periods of time.

Thus, the acquirer may specify in the customer preference information, periods of time in which the location-based ordering service should operate. For instance, the acquirer may specify that a coffee should be ordered from his local coffee shop if the acquirer is within a given range between the hours of 06:00 AM and 08:00 AM. The acquirer may also specify periods of time in which an order should not be triggered or transmitted, or in which the acquirer should be prompted to verify whether an order should be placed. This is particularly advantageous, for example, if the acquirer will pass by the local coffee shop several times per day, but only wishes to purchase a coffee on some of those occasions. The acquirer may also specify a preferred number of orders within the period of time, such as maximum number or minimum number. For example, the customer may specify one order per hour, or one order per day.

The customer preference information may specify one or more geographical regions. The processor may be further configured to cause the cause the transmission subsystem to transmit or trigger an order for one or more products or services only when the location of the mobile device is determined to be within the one or more geographical regions. The geographical region may be an area including all locations within a predetermined distance of a product or service provider, for example.

Hence, rather than specify a particular location at which the acquirer has arrived, the location on which triggering or transmission of an order is based may be a location within a predefined region (such as an area covered by a particular postcode); or within a particular distance from a supplier.

The processor may be configured to receive availability information from the product or service provider indicating whether the one or more products or services specified in the customer preference information is available.

This is particularly advantageous to prevent orders from being triggered or transmitted when the supplier to whom the order is directed lacks the products or services being sought. The availability information may be received at intervals, such as once per day, or upon request.

The processor may be configured to receive capacity information from the product or service provider indicating whether the product or service provider has capacity to offer the one or more products specified in the customer preference information.

This is particularly advantageous to prevent orders from being triggered or transmitted when the supplier to whom the order is directed lacks the capacity to deliver the sought after products or services. This is particularly useful if a supplier is likely to become extremely busy to such an extent that it cannot process further orders at certain times of day. The capacity information may be received at intervals, such as once per day, or upon request.

The processor may be configured to determine a target transmission time to transmit or trigger the order, and cause the transmission subsystem to transmit or trigger the order at the target transmission time.

By ‘target transmission time’ it is meant the time at which the order is to be transmitted. For example, based upon the acquirer's location, the processor may compute the time it will take the acquirer to arrive at the supplier. With this information, the processor may therefore compute the time at which the order should be triggered or transmitted such that the goods are ready for collection (i.e. prepared) when the acquirer arrives at the supplier, but are not prepared too early.

The processor may be configured to determine a target fulfilment time for the product or service provider to fulfil the order, and cause the transmission subsystem to transmit the target fulfilment time to the product or service provider. For example, based upon the acquirer's location, the processor may compute the time it will take the acquirer to arrive at the supplier and provide this information to the base station of the supplier. With this information, the base station may therefore compute the time at which the goods should be ready for collection (i.e. prepared).

The processor may be configured to access information pertaining to a plurality of product or service providers. Moreover, the memory may be configured to store information pertaining to a preselected plurality of product or service providers. Moreover, the preselected plurality of product or service providers may be specified in the customer preference information.

The processor may be configured to determine a destination product or service provider from the plurality, or the preselected plurality, of product or service providers, and cause the transmission subsystem to transmit or trigger the order to said destination product or service provider.

This is particularly advantageous because it enables the acquirer to specify more than one supplier with which an order may be placed. For example, the acquirer may wish to purchase a coffee from any one of three coffee shops en route to work. With this information stored in the customer preference information, the processor may determine which of those three would be most suitable for fulfilling the acquirer's order, and triggering or transmitting the order to that supplier.

The processor is configured to determine the destination product or service provider based on location information. The location information may include, for example, the determined location of the mobile device.

For instance, the aforementioned three coffee shops specified in the customer preference information may be at different locations, and the processor may elect to send the order to the closest of the three to the mobile device. Alternatively, based on the determined location of the mobile device, the processor may elect to send the order to the coffee shop which the acquirer subsequently visited when he or she was previously at the determined location.

The processor may be configured to utilise a route service to calculate one or more of the target transmission time, target fulfilment time and destination product or service provider. The route service may be configured to receive the locations of the mobile device and the product or service provider; determine at least one route between the mobile device and the product or service provider, and estimate the time required to complete the least one route.

A route service which is known by a skilled person is Google Maps.

Thus, the processor may elect to send the order to the coffee shop which would take the acquirer the least amount of time to arrive at, based on the estimates provided by the route service.

The processor may be configured to determine the current speed of the mobile device, and estimate the time to complete the at least one route based on the determined current speed. The processor may be configured to determine the current trajectory of the mobile device, and select a route based on the determined current trajectory.

Speed and trajectory of the acquirer may be used by the processor to improve its prediction as to which one of a plurality of providers an order should be sent, either based on its current knowledge of where the acquirer is in relation to the one or more service providers, or else based on which supplied the acquirer subsequently visited when he or she previously exhibited a similar speed or trajectory.

The memory may be configured to store historical data pertaining to routes previously completed by the mobile device. The data may include one or more of: selected routes, speed over the selected routes, trajectory during the selected routes, and time taken to complete the selected routes. The processor may be configured to determine one or more of the target transmission time, target fulfilment time and destination product or service provider based on the historical data and one or more of the determined location, current speed and current trajectory of the mobile device.

This is particularly advantageous because the processor may build a picture of the acquirer's habits using historical information of the acquirer's previous locations; speed; time of day and trajectory (over a portion of or a whole of a given journey). By storing correlations between the historical information and the supplier which the acquirer subsequently visited, the processor will become better able to predict which supplier the acquirer will visit by comparing historical information with current circumstances.

The processor may be configured to cause the transmission subsystem to transmit periodic updates of the target fulfilment time to the product or service provider.

This is particularly advantageous because it permits a product or service provider to accommodate delays or miscalculations in an acquirer's journey, and make appropriate adjustments to the preparations of the goods.

The processor may be configured to determine one or more of the target transmission time; target fulfilment time; and destination product or service provider, based on availability information provided by one or more of the plurality of product or service providers.

For instance, taking the above example of coffee shops further, the processor may receive information that the coffee shop closest to the acquirer does not have sufficient stock of the goods specified in the customer preference information, but that the second and third closest do. The processor may then select one of the second and third closest coffee shops and provide updated target transmission time or target fulfilment time, as required.

The processor may be configured to determine one or more of the target transmission time; target fulfilment time; and destination product or service provider, based on capacity information provided by one or more of the plurality of product or service providers.

For instance, taking the above example of coffee shops still further, the processor may receive information that the coffee shop closest to the acquirer does not have sufficient capacity to serve another acquirer, but that the second and third closest do. The processor may then select one of the second and third closest coffee shops and provide updated target transmission time or target fulfilment time, as required.

The processor may be further adapted to combine a first order transmitted or triggered by the transmission system with a second order for one or more products or services specified in the customer preference information to create a combined order; wherein the customer preference information specified in the first and second orders relates to different acquirers.

This is particularly advantageous because it enables two or more acquirers to obtain products or services using the present invention without all acquirers having to visit the supplier. For example, an order from one acquirer may be combined with an order of another, such that only one of the two acquirers need present themselves at the supplier to obtain the goods on behalf of both acquirers.

The present invention also provides a mobile device for implementing a system as described above; wherein each of the processor, memory, means for determining location, and transmission subsystem is either local to or comprised in the mobile device, or provided on a server or base station with which the mobile device is configured to communicate.

In certain embodiments, therefore, there is no need for a server at all because the processor, memory, means for determining location, and transmission subsystem may be provided on the mobile device, which may be configured to communicate with a base station directly.

The mobile device may further comprise an output device for generating an alert. The processor may be configured to cause the output device to generate an alert when the determined location of the mobile device is within the one or more geographical regions specified in the customer preference information, and more preferably only if geographical region contains one or more suppliers providing goods which are specified in the customer preference information.

This is particularly advantageous because an acquirer may be alerted to a supplier which is close by to the acquirer, and which is offering goods for sale which an acquirer may wish to purchase. The processor may first access the customer preference information and/or the catalogue information to make a determination as to whether the acquirer should be alerted to the supplier.

The processor may be configured to cause the output device to generate the alert only during the one or more periods of time specified in the customer preference information. The processor may be configured to cause the output device to generate an alert only when the product or service provider within the predetermined range indicates that the one or more products or services specified in the customer preference information is available. The processor may be configured to cause the output device to generate an alert only when the product or service within the predetermined range indicates that it has capacity to offer the one or more products or services specified in the customer preference information. Availability and capacity are discussed in more detail above.

The mobile device may further comprise an input device configured to receive a user input indicating that an order should be transmitted or triggered upon receipt of the alert. The processor may be adapted to transmit or trigger the order upon receipt of the user input.

This is particularly advantageous if the user wishes to override or supplement the location-based aspect of the system described above with a facility to transmit or trigger orders manually, for example.

The processor may be further adapted to authorise a second order for one or more products or services specified in the customer preference information to be combined with a first order to create a combined order; wherein the customer preference information specified in the first and second orders relates to different customers.

The present invention also provides a server for implementing a system described above; wherein each of the processor, memory, means for determining location, and transmission subsystem is either local to or comprised in the server, or provided on a mobile device or base station with which the server is configured to communicate.

Each of the processor, memory, means for determining location, and transmission subsystem may either be local to or comprised in the base station, or provided on a mobile device or server with which the base station is configured to communicate.

Wherever the processor is provided, it may be further configured to cause the transmission subsystem to transmit or trigger an offer from the product or service provider to the mobile device for one or more products or services.

The processor may be further configured to cause the transmission subsystem to transmit or trigger an offer only when the determined location of the mobile device is within the one or more geographical regions specified in the customer preference information.

The processor may be further configured to cause the transmission subsystem to transmit or trigger an offer only during the one or more periods of time specified in the customer preference information.

The processor may be further configured to cause the transmission subsystem to transmit or trigger an offer only when the product or service provider indicates that the one or more products or services being offered is available.

The processor may be further configured to cause the transmission subsystem to transmit or trigger an offer only when the product or service provider indicates that it has capacity to offer the one or more products or services being offered.

These aspects are described in more detail above.

The base station may further comprise a display. The display may be configured to display the order upon receipt of the order at the base station.

The present invention also provides a method for ordering a product or service from a product or service provider, utilising a mobile device, comprising: storing customer preference information specifying one or more products or services; determining a location of the mobile device; and transmitting or triggering an order for one or more products or services specified in the customer preference information to a base station located at the product or service provider based upon the determined location of the mobile device.

The optional features described above in respect of the system, mobile device, server and base station are also applicable to the method referred to in the previous paragraph.

The present invention also provides, in a second aspect, a system for identifying an acquirer of a product or service from a product or service provider, comprising: an input device configured to capture an input signal; a processor configured to access: a record associated with one of a plurality of acquirers; and recognition data about each acquirer; and an output device; wherein the processor is configured to: process the input signal, or send the signal to a remote device for processing, to determine whether the input signal corresponds to the recognition data about any one of the plurality of acquirers; and upon detection of a correspondence, cause the output device to output an identity signal.

The identity signal serves to give, at the very least, an indication that the acquirer in respect of whom a correspondence was detected has been identified. The identity signal may be a simple alert such as one or more audio tones submitted by a speaker; or one or more visual cues such as the flashing of a light emitting device (LED or light bulb).

Alternatively the identity signal may be a representation of at least part of the record associated with the acquirer in respect of whom a correspondence was detected.

By ‘identifying’ it is meant associating an acquirer who may present himself or herself at the supplier, having previously placed an order, with the previously placed order. Identifying does not necessarily imply a presentation of information to a human to enable the human to recognise the acquirer, although this is preferred.

By ‘recognition data’ it is meant any piece of information about a known acquirer (that is, an acquirer who has previously supplied that information) which may be compared with corresponding captured information about an actual acquirer (that is, an acquirer who has presented himself or herself at the supplier), and thus used to provide an indication, within a given degree of certainty, as to whether the actual acquirer is the known acquirer.

By ‘record’ it is meant a current, pre-existing or previous order; or an entry pertaining to an acquirer in a customer relationship management (CRM) database, for example.

The piece of information may be about the acquirer's identity, biometrics, bodily characteristics or location, for example.

The output device may be a speaker; and the processor may be configured to cause the speaker to emit an audio representation of the record. For example, the audio representation may be an electronic speech of the words contained in the record.

The output device may be a display device; and the processor may be configured to cause the display to show a visual representation of the record. For example, the visual representation may be an image or set of characters forming words contained in the record.

The record may comprise an image of the acquirer, and the processor may be configured to cause the display to show the image together with the visual representation of the record.

This is particularly advantageous because the supplier may thus be shown an image (such as a photograph), drawn from the record (such as from the entry in the CRM database) when an acquirer arrives at the supplier. The supplier may thus compare the photograph, or other image, of the known acquirer, with the actual acquirer who is present.

The record may comprise information including one or more of: identity information of the acquirer; a unique reference associated with the acquirer; payment information of the acquirer; information of pending orders from the acquirer; information of previous orders from the acquirer; and information of offers made to the acquirer.

The record may comprise information of when the order was submitted by the acquirer or when the acquirer expects the order to be fulfilled.

The processor may be configured to access a plurality of records associated with a plurality of acquirers and cause the display to show visual representations of each of the plurality of records. Upon detection of a match, the processor may be adapted to cause the display to change the visual representation of the record associated with the acquirer matched with the recognition data.

Thus, where a plurality of orders has been submitted, the order associated with the acquirer who is present at the supplier and has been recognised accordingly, may be brought to the attention of the supplier.

The change may be one or more of: causing the record to flash, change colour or change size, and causing the record to move to a predefined area of the display, preferably the top of the display. Of course, any technique for drawing the supplier's attention to the record would be suitable.

The recognition data about the enquirer may comprise location data relating to the location of a mobile device associated with the acquirer.

The input device may be a wireless communication terminal, and the input signal may be an attempt by the mobile device to connect to the wireless communication terminal. The processor may be adapted to detect the attempt to connect to the wireless communication terminal and process the location data to determine whether the mobile device is located within range of the wireless communication terminal.

The recognition data about the acquirer may comprise biometric data. The biometric data may comprise one or more of: data representing a bodily image of the acquirer, including: an image of the acquirer's face; data representing a bodily characteristic of the acquirer, including: a vocal characteristic, including tone or pitch of the acquirer's voice; a physical characteristic, including the acquirer's weight, height, girth and gait of the acquirer.

The input device may be a microphone and the input signal may be an audio signal spoken by the acquirer. The processor may be adapted to perform an audio recognition process on the audio signal, or send the audio signal to a remote device for performance of an audio recognition process, to determine whether the audio signal contains a match with the biometric data about the acquirer.

The input device may be a one or more cameras and the input signal may be an image or series of moving images of the acquirer. The processor may be adapted to perform an image recognition process on the image or series of moving images, or send the image or series of moving images to a remote device for performance of an image recognition process; to determine whether the image or series of moving images contains a match with the biometric data about the acquirer.

The processor may be configured to communicate with a server and receive therefrom the biometric data. The processor may be further configured to process the input signal to determine whether the signal contains a match with the biometric data received from the server.

The processor may be configured to communicate with a server, send the input signal to the server, and receive from the server information identifying the acquirer matched with the biometric data.

The system may further comprise an information display arranged to be visible to an acquirer and to indicate to the acquirer a location at which a product or service may be acquired. The processor may be configured to cause the information display to show a visual representation of the record.

The record may comprises a name or nickname of the acquirer, and the processor may be configured to cause the information display to show a visual representation of the name or nickname of the acquirer.

Also provided according to the second aspect is a method of identifying an acquirer of a product or service from a product or service provider, comprising: capturing an input signal with an input device; accessing recognition data about a plurality of acquirers; processing the input signal, or sending the signal to a remote device for processing, to determine whether the signal corresponds to recognition data about any one of the plurality of acquirers; upon detection of a correspondence, accessing a record associated with the acquirer in respect of whom the correspondence was detected and outputting an identity signal.

The optional features described above in respect of the system are also applicable to the method referred to in the previous paragraph.

Also provided in the third aspect is a system for authenticating an acquirer of a product or service from a product or service provider, comprising: a base station configured to process a plurality of pending orders for one or more products or services from a corresponding plurality of acquirers, each acquirer being associated with (for example, in possession of) a mobile device; a processor configured to create and/or access an identifier associated with each of the plurality of pending orders; an output device, wherein the processor is configured to cause the output device to show a representation of at least one of the plurality of pending orders; and a transmission subsystem configured to communicate with the mobile device of each of the plurality of acquirers and transmit the identifier associated with one pending order to the mobile device of the corresponding acquirer to enable the acquirer to be authenticated.

By ‘authentication’ it is meant ensuring that the actual acquirer present at the supplier is the originator of the order received by the supplier. For the purposes of the present description it is assumed that the acquirer has access to his or her mobile device; that is, that the mobile device is not stolen or accessed illegitimately. With only this caveat, this aspect of the invention permits a supplier to ensure that the actual acquirer present at the supplier is the originator of the order being processed by the suppler.

The system therefore permits customers to pay for goods (i.e. complete a transaction) without having to exchange physical money or a payment token such as a credit, debit or loyalty card.

In the context of the present description, orders may be ‘pending’ or ‘complete’. By ‘pending’ it is meant orders which have been received by the base station from one or more acquirers, but which have not yet been fulfilled; that is the goods have yet to be collected by the acquirer and a transaction has yet to be processed. Once the goods have been collected and/or a transaction has been processed, the order is deemed to have been fulfilled and is finalised. It then ceases to be ‘pending’ and instead becomes ‘complete’.

The output device may be a display device and the processor may be configured to cause the output device to show a visual representation of at least one of the plurality of pending orders.

The processor may be further configured to cause the display device to show a visual representation of the identifier together with each of the displayed plurality of pending orders, such that an identifier received by a mobile device may be compared with the identifiers shown on the display device.

The system may further comprise an input device configured to capture an input. The processor may be further configured to process the input, or send the input to a remote device for processing, to determine whether the input matches an identifier.

This is particularly advantageous to speed up the process by which authentication takes place. Processing may take place at the supplier's base station or, if preferred, at a remote location such as a server.

The input device may be a camera, and the input may comprise an image or series of moving images displayed on the mobile device. The processor may be adapted to perform an image recognition process on the image or series of moving images, or send the image or series of moving images to a remote device for performance of an image recognition process, to determine whether the image or series of moving images matches the identifier.

The input device may be a barcode or QR code reader, and the input may be a barcode or QR code displayed on the mobile device. The processor may be adapted to process the barcode or QR code to determine whether the barcode or QR code matches the identifier.

The identifier may comprise one or more of: an alphanumeric code, preferably a randomly generated alphanumeric code; a predefined password; identity details of the acquirer, including a name or nickname of the acquirer; the whole or part of the order; the cost of the order; the time of transmission of the order; the location of transmission of the order; and any combination of two or more of the above.

The input device may be a microphone and the input may comprises an audio signal spoken by the acquirer or emitted by the mobile device. The processor may be adapted to perform an audio recognition process on the audio signal, or send the audio signal to a remote device for performance of an audio recognition process, to determine whether the audio signal matches the identifier.

The identifier may comprise one or more of: an alphanumeric code, preferably a randomly generated alphanumeric code; a letter, number, word or phrase; or one or more audio tones of preselected frequency, duration, and/or volume.

The processor may be configured to cause the transmission subsystem to transmit the identifier upon selection of one of the plurality of pending orders by the product or service provider.

The system may further comprise a wireless communication terminal; and the processor may be configured to cause the transmission subsystem to transmit the identifier upon detection of an attempt by the mobile device to connect to the wireless communication terminal.

Also provided in the third aspect is a method of authenticating an acquirer of a product or service from a product or service provider, comprising: processing a plurality of pending orders for one or more products or services from a corresponding plurality of acquirers, each acquirer being associated with (for example, in possession of) a mobile device; accessing an identifier associated with each of the plurality of pending orders; outputting, on an output device, a representation of at least some of the plurality of pending orders; and transmitting the identifier associated with one pending order to the mobile device of the corresponding acquirer to enable the acquirer to be authenticated.

The optional features described above in respect of the system are also applicable to the method referred to in the previous paragraph.

### BRIEF DESCRIPTION OF THE DRAWINGS

Preferred embodiments of the aforementioned aspects of the present invention will now be described in detail with reference to the accompanying drawings, in which:

FIG. 1 is a diagram of an exemplary mobile device according to the present invention;

FIG. 2 is a diagram of an exemplary base station according to the present invention;

FIG. 3 is a diagram of an exemplary server according to the present invention;

FIG. 4 is a process flow diagram showing a preferred implementation of the systems and methods according to the present invention;

FIGS. 5 to 9 are process flow diagrams showing data flows between components in various aspects of the present invention;

FIG. 10 is a process flow diagram showing a registration process for implementing the systems and methods according to the present invention;

FIG. 11 is an overview of the system interface between components in various aspects of the present invention;

FIG. 12 is a display output of a requester/supplier log in view;

FIGS. 13A to 13D are display outputs of various views that an acquirer can use to order goods from a supplier;

FIG. 14 is a display output of a view that an acquirer may use to configure an automatic or location-based order;

FIGS. 15A and 15B are display outputs of a customer registration screen;

FIG. 16 is a display output of a view in which orders have been received remotely; and

FIG. 17 is a display output of a view that may be used to verify an acquirer.

### DETAILED DESCRIPTION

The following is a detailed description of a preferred implementation of the various aspects of the system. Each aspect of the invention may be implemented in isolation of the other aspects and in isolation of the specific features referred to in the following detailed description, in certain circumstances. Alternatively, any combination of aspects may be implemented, depending on the needs of the skilled person.

Broadly, the following systems and methods comprise utilising communications networks and software applications, executable in various modes of application, which may be installed on any capable device able to communicate via the communications networks. Typical devices include a mobile device such as a mobile telephone or tablet computer. In some embodiments, the systems and methods may comprise an online set of services accessible to acquirers and product and service providers using accounts.

In certain implementations of the invention, acquirers and service providers may be required to open an account to gain access to the software applications mentioned above and to provide certain details useful for the system to operate. For the acquirer, these details may include contact details; biometric details; payment information sufficient to facilitate a transaction and pay for goods or services; customer preference information; and so on. Payment details may include information to facilitate payment via a phone bill, credit or debit card, direct debit, ePay account or any other payment method. For the service provider, these details may include contact details, including location information; financial details sufficient to receive a payment; catalogue information; and so on.

The systems and methods of all three aspects of the present invention referred to above may be implemented by one or more components distributed across a wireless network.

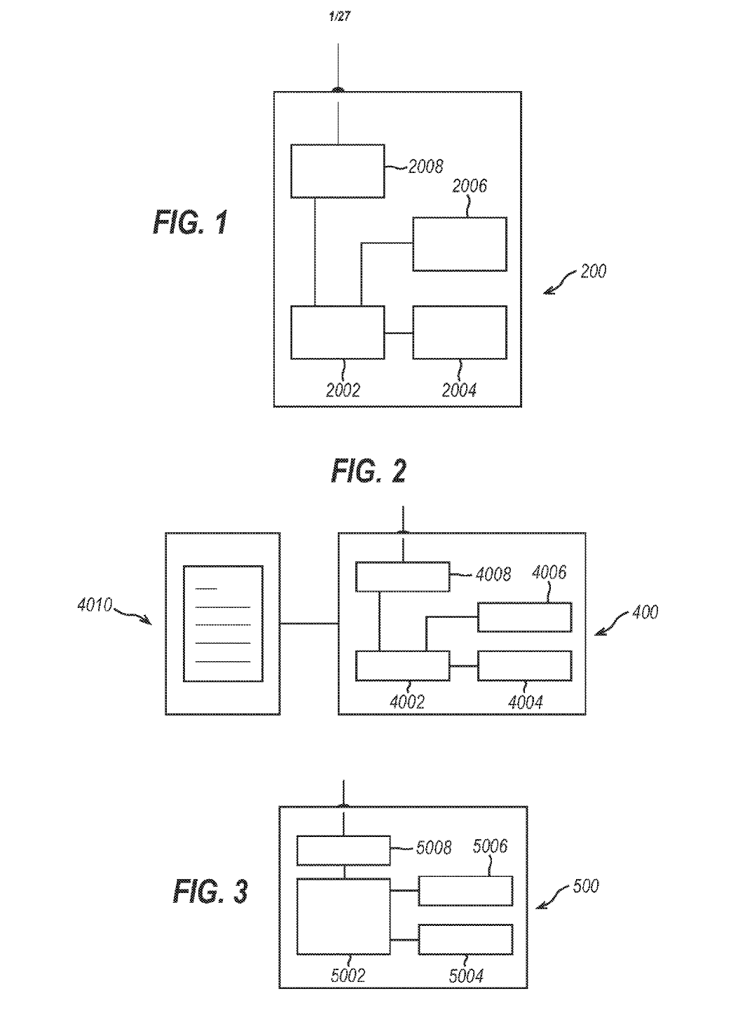

The distributed components are shown in FIGS. 1 to 3. These components include a mobile device 200, such as a cellular telephone, which is in the possession of an acquirer. The mobile device may comprise one or more of a processor 2002, a memory 2004, means for determining the location of the mobile device 2006 (and therefore the location of the acquirer in possession of the mobile device) and a transmission subsystem 2008. The means for determining location of the mobile device may be any suitable means such as a GPS device on the device which determines location using GPS satellite signals, as a skilled person would understand. The transmissions subsystem may be a system for communication over a cellular network, using 2G, 3G, 4G or EDGE, for example; or else a system for communicating via a wireless network, including Bluetooth® and the like.

The distributed components also include a base station 400, such as a computing device (including a tablet PC, a computerised till and the like), located at a product or service supplier. The base station may comprise one or more of a processor 4002, a memory 4004, means for determining the location of a mobile device 4006 (and therefore the location of the acquirer in possession of the mobile device) and a transmission subsystem 4008. The base station 400 may also include a display device 4010. In this case, the means for determining location of the mobile device may be a data connection with the mobile device to receive location information determined by the mobile device itself. Alternatively, the means for determining location may be a wireless network connection to the mobile device. In that case, the location of the mobile device may be determined based on the signal strength of the mobile device, or based on the wireless network terminal to which the mobile device is connected. The transmissions subsystem may be a system for communicating over a cellular network, using 2G, 3G, 4G or EDGE, for example; or else a system for communicating via a wired network, including a modem, ASDL, optical fibre or ISDN connection and the like; or else a system for communicating via wireless network, including Bluetooth® and the like.

The distributed components also include a server 500, such as a network server, located remote from the mobile device and the base station but configured to be in communication with both. The server may comprise one or more of a processor 5001, a memory 5004, means for determining the location of a mobile device 5006 (and therefore the location of the acquirer in possession of the mobile device) and a transmission subsystem 5008. In this case, the means for determining location of the mobile device may be a data connection with the mobile device to receive location information determined by the mobile device itself. Alternatively, the means for determining location may be a cellular or wireless network connection to the mobile device. In that case, the location of the mobile device may be determined based on the cellular or wireless network terminal to which the mobile device is connected. The transmissions subsystem may be a system for communicating over a cellular network, using 2G, 3G, 4G or EDGE, for example; or else a system for communicating via a wired network, including a modem, or ISDN connection and the like; or else a system for communicating via wireless network, including Bluetooth® and the like.

Preferably, all transactions would be sent over the internet from the mobile device to the base station, via a server. However wherever available, peer-to-peer (e.g. via WiFi or Bluetooth) communications may be used in the cases where internet connections are not possible or are too slow.

When implementing the system of the present invention, it is a matter of preference as to which of the distributed components comprises the aforementioned features. For example, the processor, memory, means for determining a location and transmission subsystem may be provided on the mobile device. Alternatively, these features may be provided on the server, or on the base station. Moreover, any combination of features on the mobile device, base station and server may be provided.

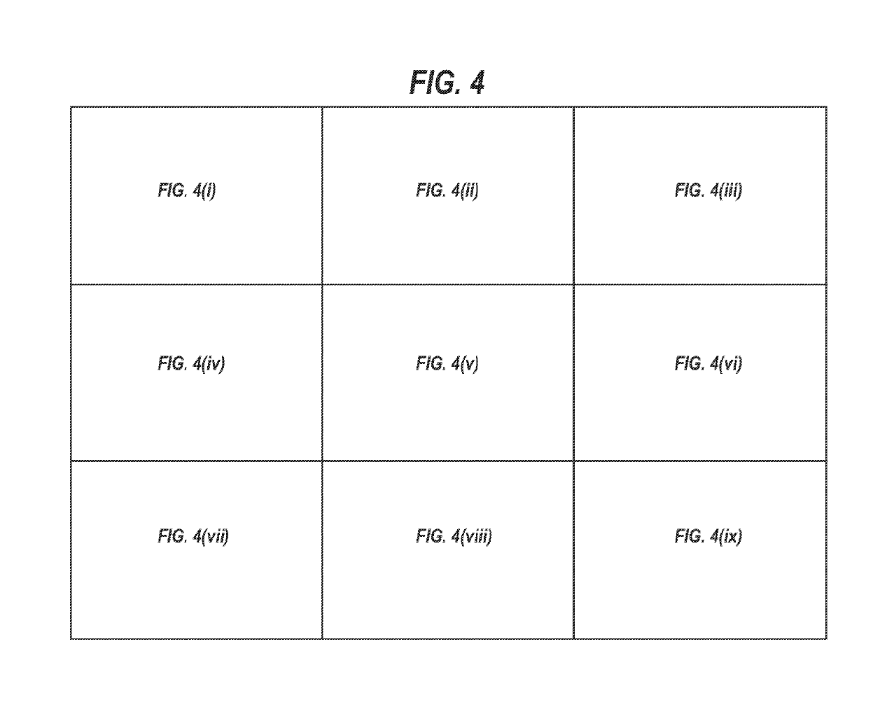

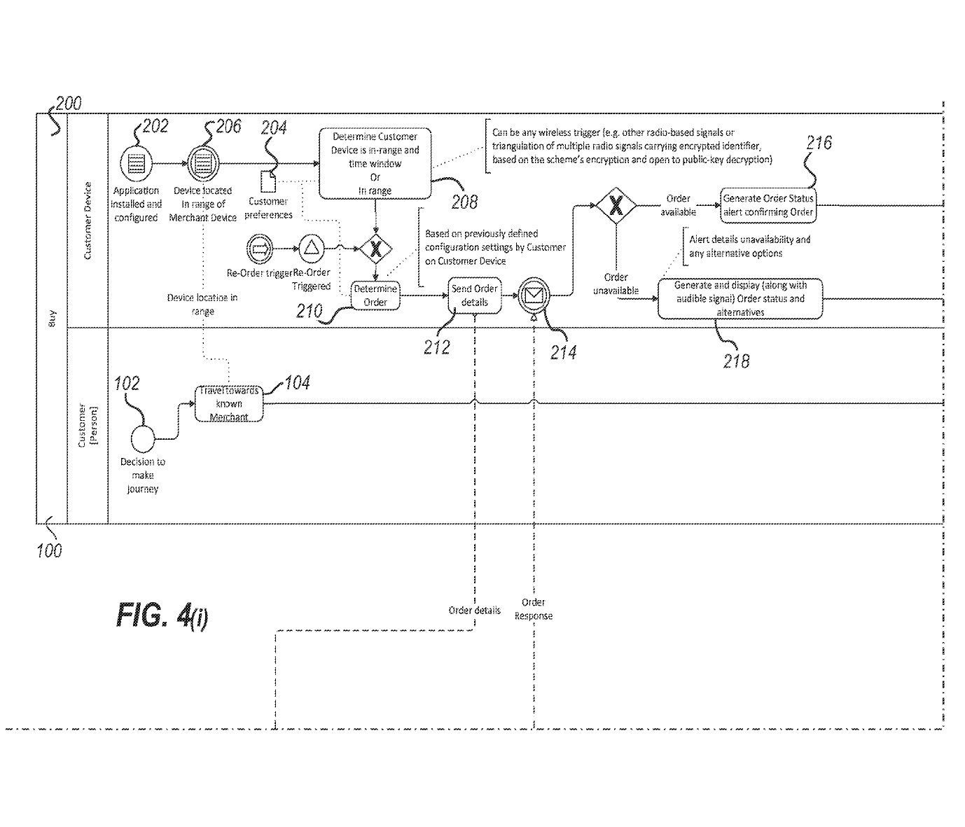

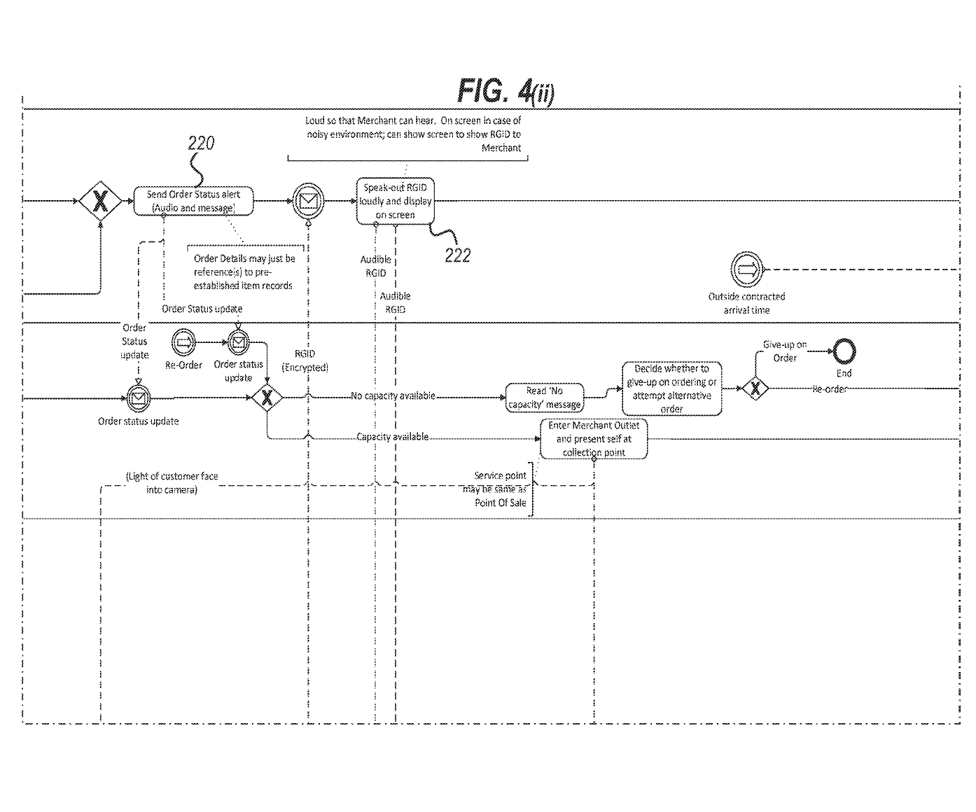

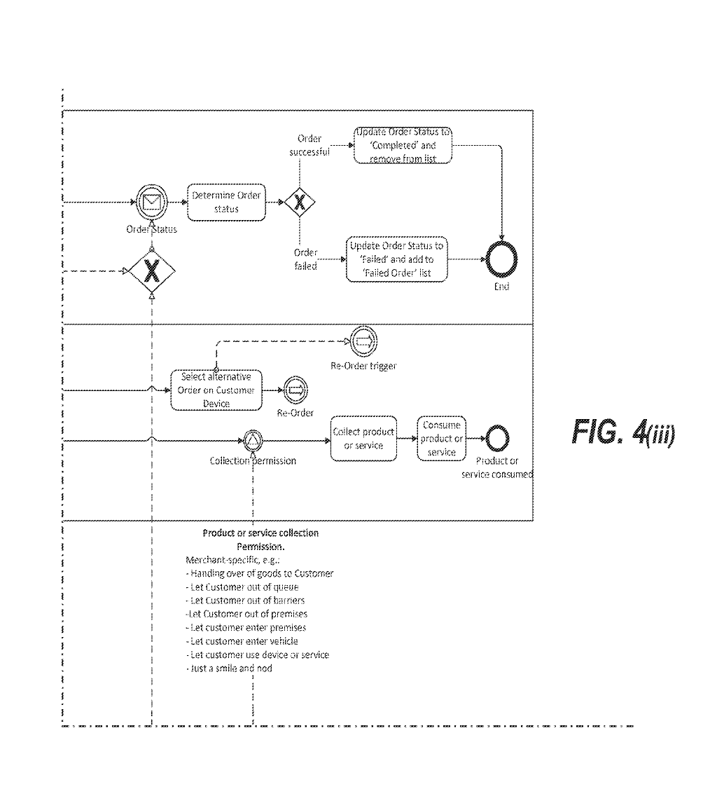

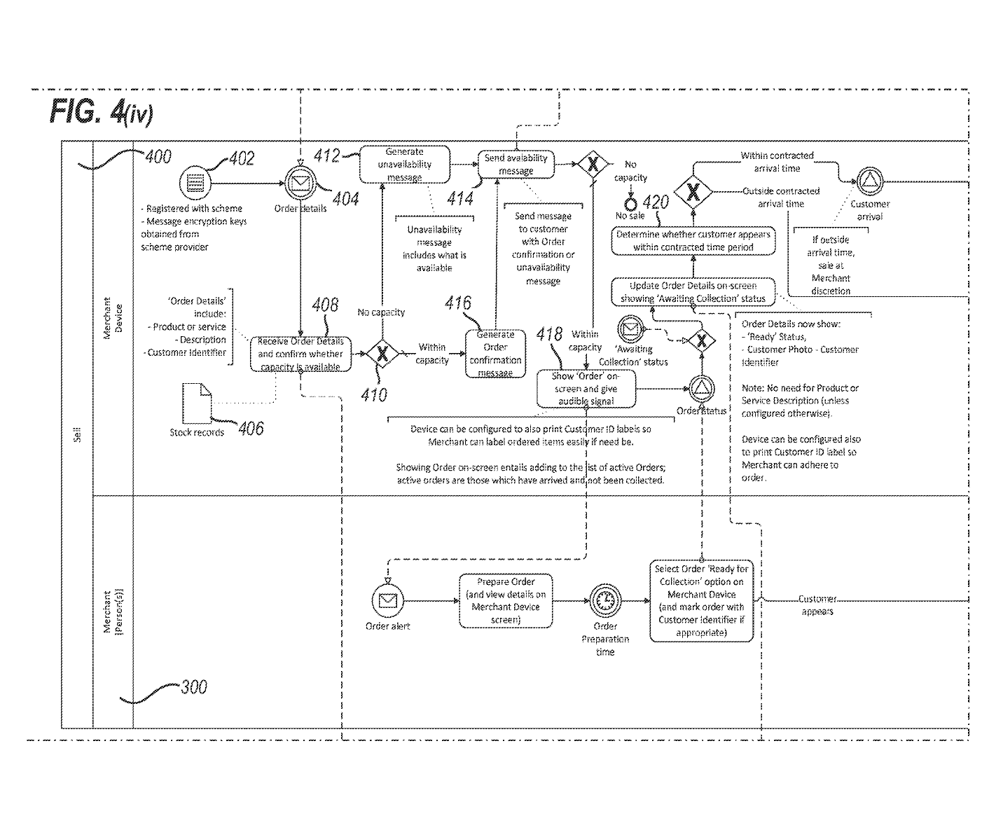

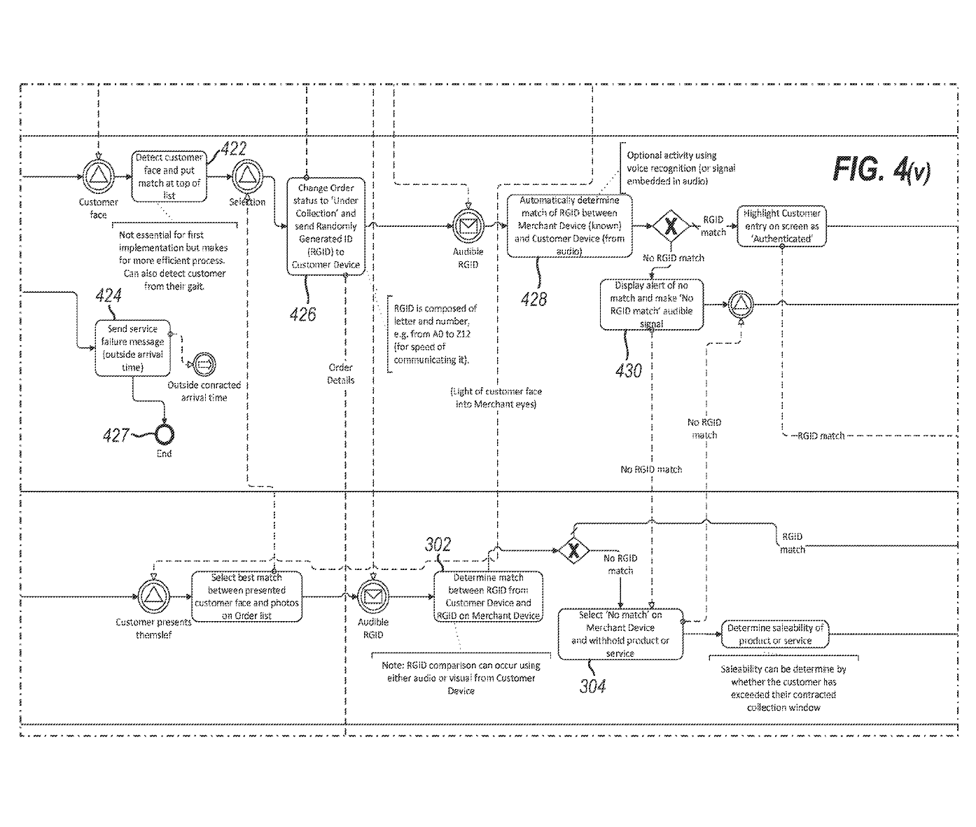

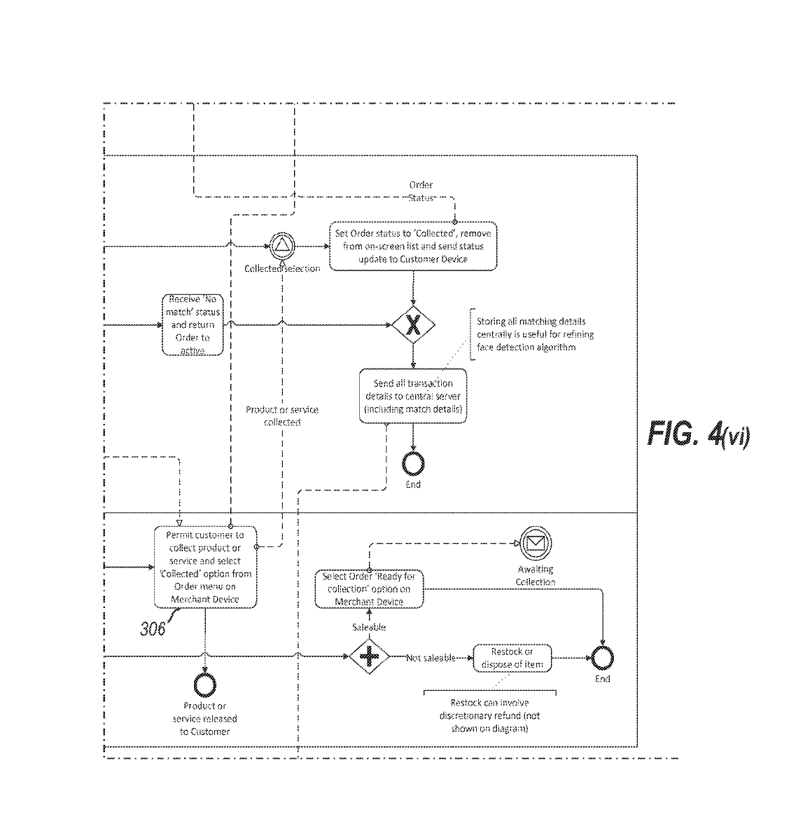

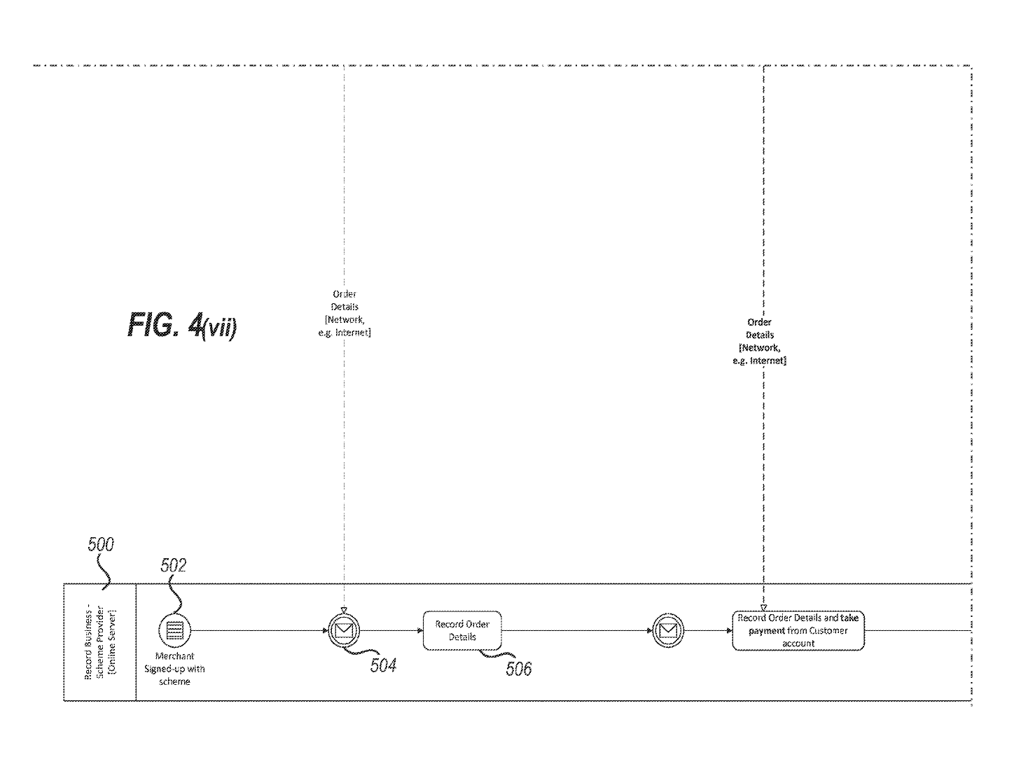

FIG. 4 shows a workflow diagram of a first embodiment of the system of the present invention. In particular, the system is for ordering a product or service from a product or service provider. The workflow shows actions performed by an acquirer 100 in possession of a mobile device 200, together with actions performed by a product or service provider (merchant or supplier) operating a base station 400. The workflow diagram also shows a server 500 in communication with the mobile device 200 and the base station 400.

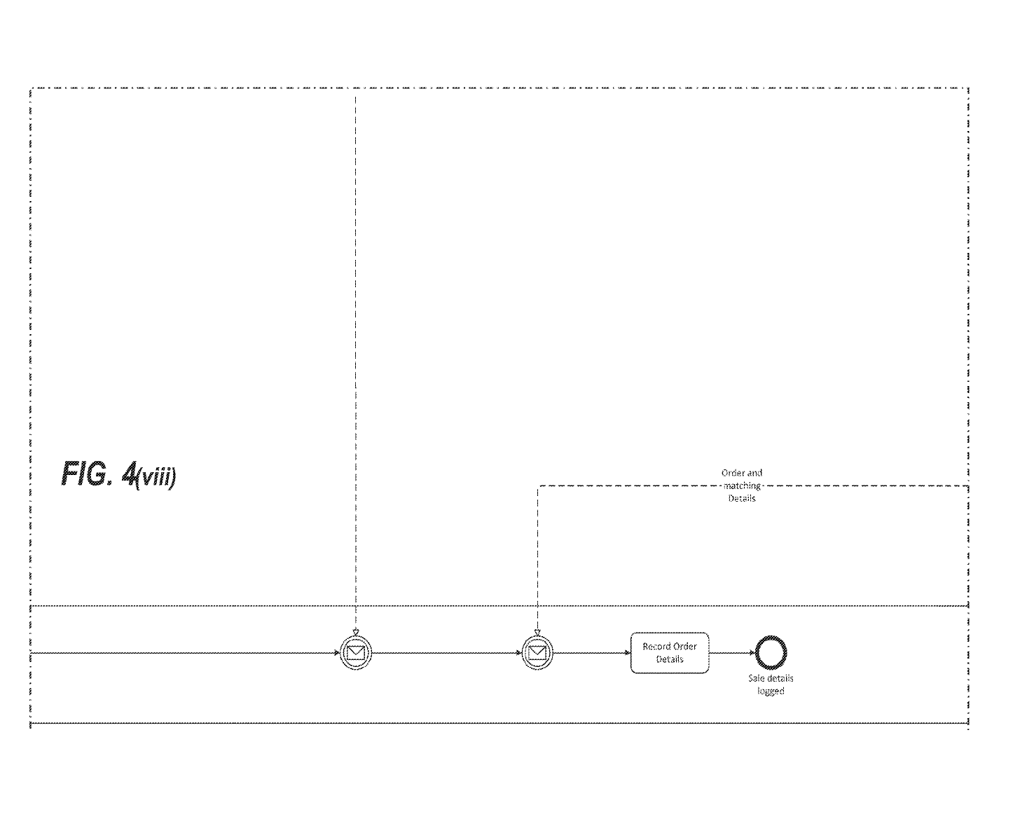

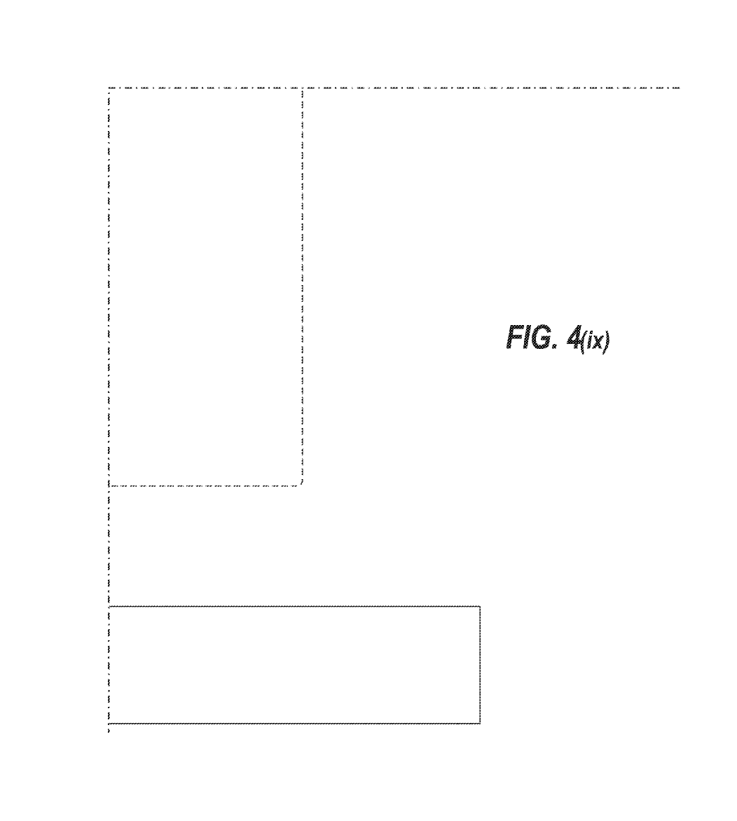

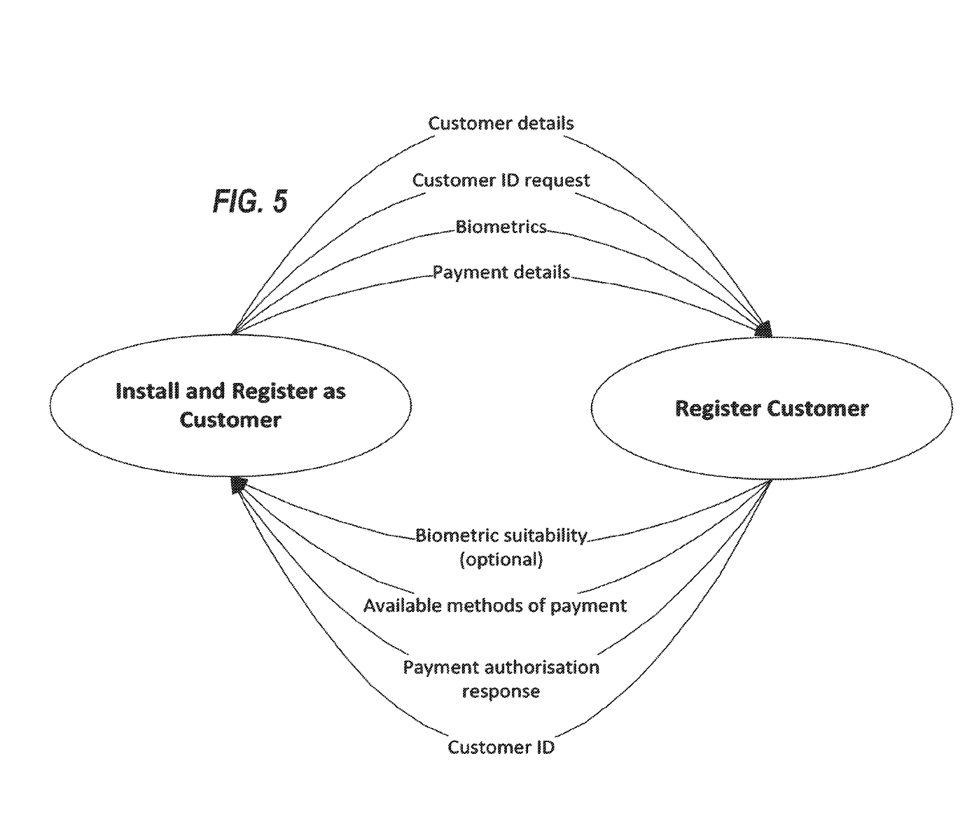

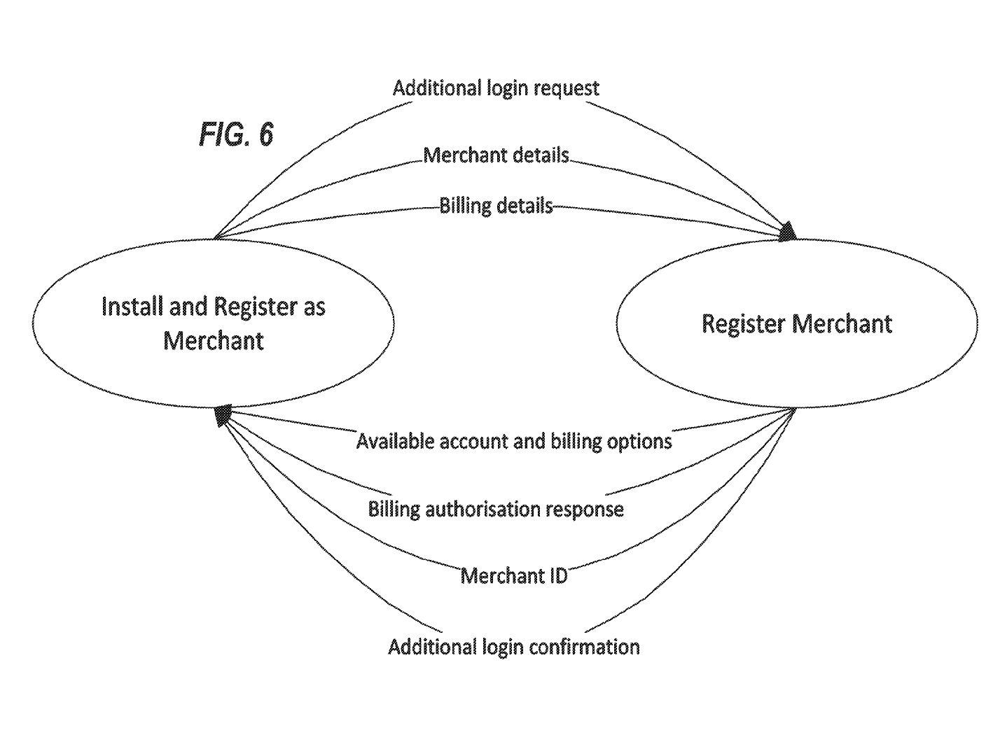

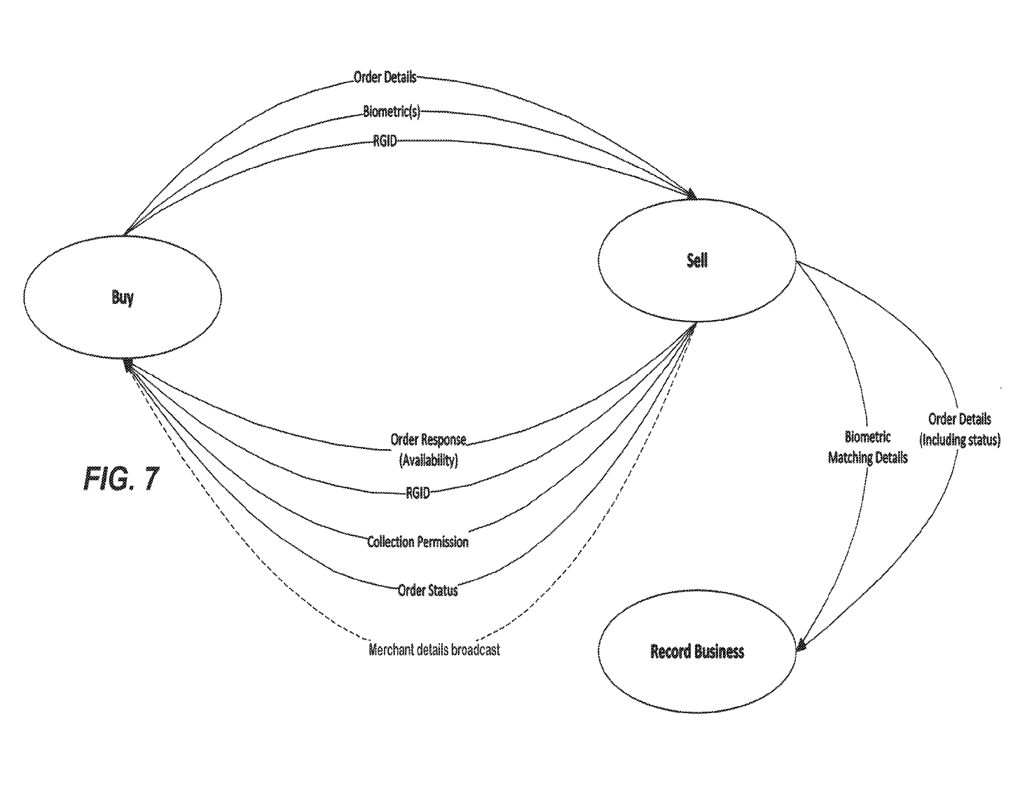

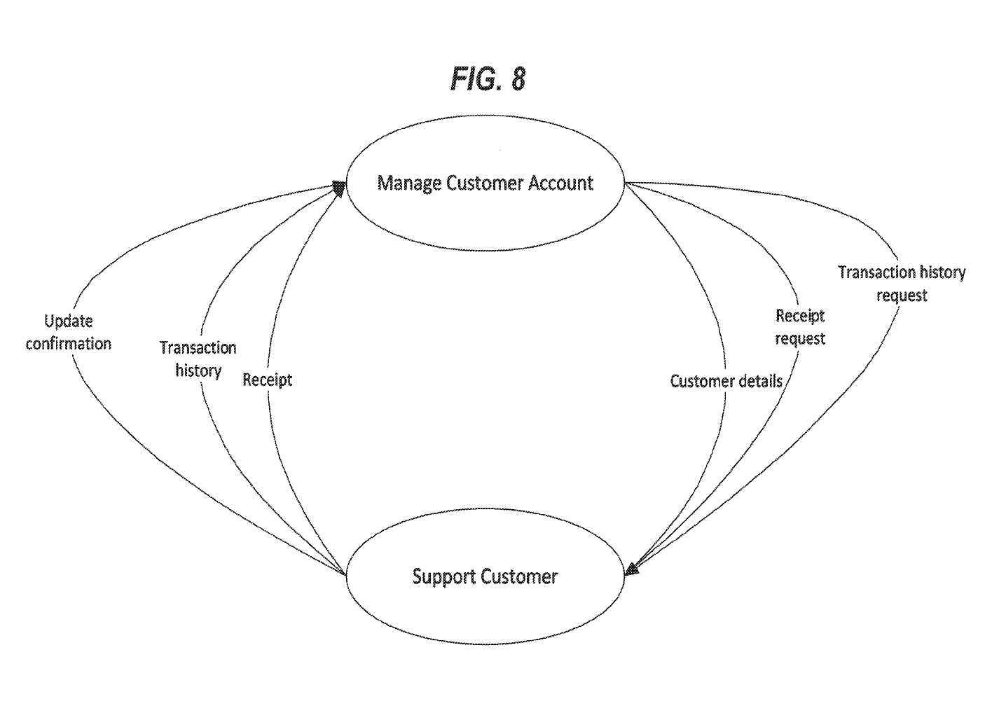

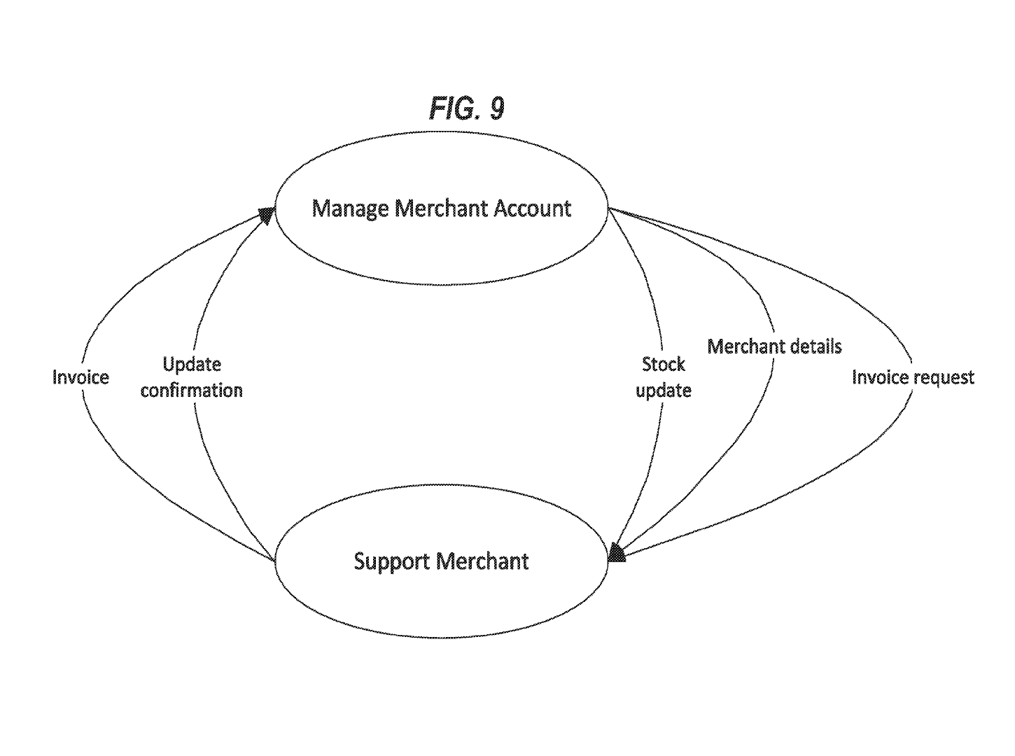

FIGS. 5 to 9 show the data flows and processes performed by the components illustrated in FIG. 4. In particular, FIG. 5 shows data flows and processes with the acquirer and the acquirer device; FIG. 6 shows data flows and processes with the supplier and the supplier device; FIG. 7 shows data flows and processes with the acquirer, supplier and server system (or scheme provider); FIG. 8 shows data flows and processes with acquirer and the server (or scheme provider); and FIG. 9 shows data flows and processes with the supplier and the server (or scheme provider).

FIGS. 5 to 9 contextualise the relationship between key processes and key information. Processes are represented as ellipses and information flow as arrows, each labelled with text. The data comprising the information represented by arrows may be automatically generated and are indicative of what the process generates, rather than what entity (e.g. system or person) performs the generation.

The data flow arrows are not in any particular order and can occur at any time or repeatedly throughout the lifetime of a process.

These diagrams do not contain an exhaustive set of information; they are only used to convey the context of some key processes involved with respect to some key information which flows between them. Moreover, the figures show only an exemplary implementation of the invention, and should not be understood as limiting. A better understanding of the full scope of the invention will be gained by reference to the appended claims and the complete description of each aspect of the invention given below.

With reference to FIG. 5, the following processes and information flows are shown:
Install and Register as Acquirer
The process which the Acquirer undergoes to create an account with the scheme and start using the application.
Register Acquirer
The process which occurs on the supplier device, which in-turn communicates with the scheme services to process service requests as necessary.
Customer Details
Comprised of data such as name, address, mobile number, password.
Customer ID request
Comprised of preferential text provided by the acquirer with the intent of formulating a unique identifier which they can identify with.
Biometric
Comprised of customer biometric details, such as a photograph, a video clip, a sound clip or a combination of these.
Biometric suitability
A response to the submission of biometric details which indicates whether the biometrics provided can be used for the purposes of the system. This could be a status such as “suitable” or a reason as to why the biometrics provided cannot be used for the purposes of the system (for example if a photograph is not of sufficient quality).
Available methods of payment
A description and corresponding parameters for the available methods of payment the acquirer can use for providing payment into the system (e.g. PayPal log-in, Direct Debit details or Credit or Debit card details).
Payment authorisation response
Informs of the success of the payment details after processing them and a request for any further details which may be required.
Customer ID
Confirmation of a successful acquirer identifier. This can also include any message pertaining to the suitability of the password or other details provided such as the Acquirer ID requested.

With reference to FIG. 6, the following processes and information flows are shown:
Install and Register as Merchant
Process whereby a supplier member of staff can obtain a supplier mobile application and create or amend an account on the system, assuming with the intent of using it to transact. This process will include a sub-process whereby the application is downloaded and installed onto the supplier device.
Register Merchant
Process whereby the system actually creates an appropriate record of a supplier with the assumed intent they use the system to transact.
Additional login request
Allows the supplier who registered to request login accounts for staff. Such a request can be for another supplier account administrator or for other members of staff with more restricted access to the system. E.g. the registrant who provides billing details for the supplier to be remunerated has the authority to update such details and would be assigned, for example, “administrator grade” account status but another account (e.g. “staff grade”) would allow a corresponding user to only transact orders.
Supplier details
Includes information pertaining to the supplier such as the following.
   Location
   Name
   Offered products and/or services and respective prices, loyalty point value and restrictions (such as time of day available and time it takes to produce)
   Service capacity (e.g. number of staff available to service orders and of what type).
   Company number
   VAT number
   Three months of bank statements
   Desired frequency of remuneration
Billing Details
Remuneration information (the account to which the supplier receives funds from doing business). Multiple billing details can be provided and can be attributed to different categories of products or services.
Available account and billing options
Explanation of transaction charges. Details of the terms and conditions for use of the system. Confirmation of Billing details.
Billing authorisation response
Explanation as to whether the billing details were accepted.
Supplier ID
The confirmed unique identifier of the supplier on the system
Additional login confirmation
Confirmation of the login details of additional users (the provision of initial passwords can be at the discretion of the supplier—or example if no email address of the additional user is provided). Such an exposed password will have to be changed as per usual process on the supplier device before it can be used to transact.

With reference to FIG. 7, the following processes and information flows are shown:
Buy
Process undergone for the provision of products and/or services.
Sell
Process undergone to obtain money for transactions.
Record Business
Process undergone which collects all necessary details of transactions to support the running of the services the system supports.
Order details
The items (e.g. just unique identifiers) for the items which are to bought by the acquirer. This will include information such as the following.
   Item ID
   Quantity
   Last known price (in case there is a discrepancy and a notification is needed requesting acquirer intervention)
   Time of order
   Location of acquirer device
   Trajectory of acquirer device
Biometric(s)
In case the supplier device does not have a copy (or current version) of the required biometrics of the acquirer, they photograph or other biometrics are pulled-down from the server to the supplier device.
RGID
This instance of the RGID is used to confirm the authentic acquirer device (it is effectively an echo of the instance described below, provided in short succession of the one below being successfully transmitted).
Order Response (Availability)
This provides confirmation of success and if not successful, what is available at the supplier who received the order.
RGID
Randomly Generated Identifier. This identifier is generated at random upon the selection of a likely acquirer (authorised recipient of products and/or services).
Collection permission
A signal or release by the supplier that a acquirer can collect their product(s) and/or service(s) they have purchased.
Order Status
An indicator describing the maturity of an order. It can be perceived as its readiness for collection. E.g. ‘Pending’, ‘In Progress’, ‘Ready for Collection’, ‘Collected’.
Supplier details broadcast
In the first instance, this can just be a supplier identifier which relates to the following richer information: Location and products or services a supplier provides. This will only be displayed on an acquirer device if the supplier matches the acquirer configured preferences.
Order Details (Including Status)
Described the order transacted
Biometric matching details
Biometric captured from the acquirer and the matching measure from the supplier device (e.g. probability of detection). This is logged against the version of matching algorithm used. This can be used to monitor the effectiveness of the matching and hone the algorithm or request an acquirer re-capture any biometrics.

With reference to FIG. 8, the following processes and information flows are shown:
Manage Acquirer Account
Process for updating and administering the information pertaining to a acquirer account.
Support Acquirer
Process supporting a set of services which facilitate acquirer administrative requests.
Acquirer details
Usually updated acquirer details such as new username, password, registering a new mobile device, new telephone number, biometric, password.
Receipt Request
Specific or general request for a proof of a transaction, pertinent to the authorised acquirer account.
Transaction History Request
Specific or general request for recorded transaction details over time, pertinent to the authorised acquirer account.
Update confirmation
Confirmation that acquirer changes have been made and if not, why not.
Transaction history
Details describing past transactions in response to the Transaction History Request.
Receipt
Proof of purchase. Usually in a standard format such as PDF or JPG (depending on user preferences) or a zip file of multiple receipts.

With reference to FIG. 9, the following processes and information flows are shown:
Manage Supplier Account
Process for updating and administering the information pertaining to a supplier account.
Support Supplier
Process supporting a set of services which facilitate supplier requests.
Stock update
Change to the product or services available at a supplier. Can be in terms of volume, price or type, for example.
Supplier Details
Authorised change to any supplier information.
Invoice request
A request for proof of business preformed on system for a pre-specified time period, as per account settings.
Invoice
Proof of business transacted on the system for the respective supplier
Update confirmation
Confirmation of any changes to supplier information or explanation as to why updates are unsuccessful.

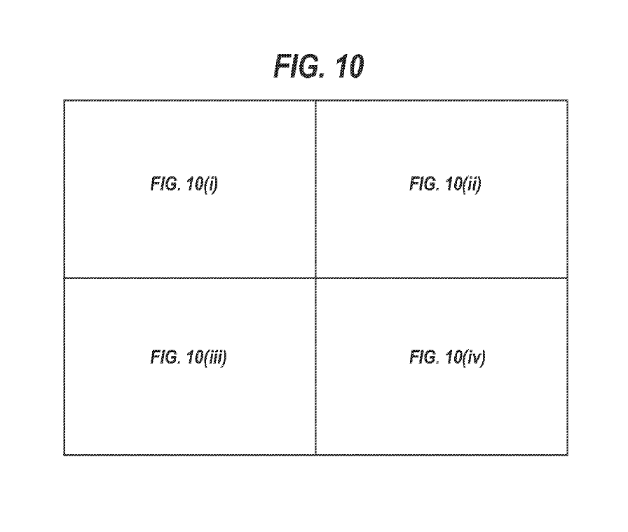

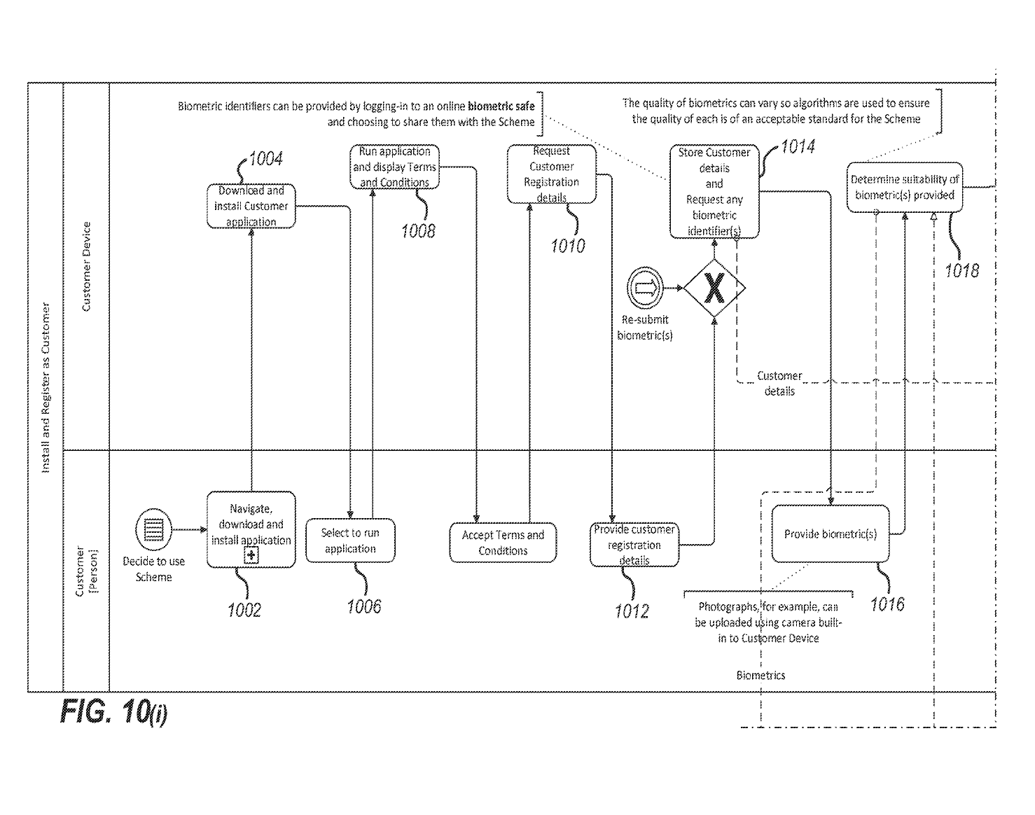

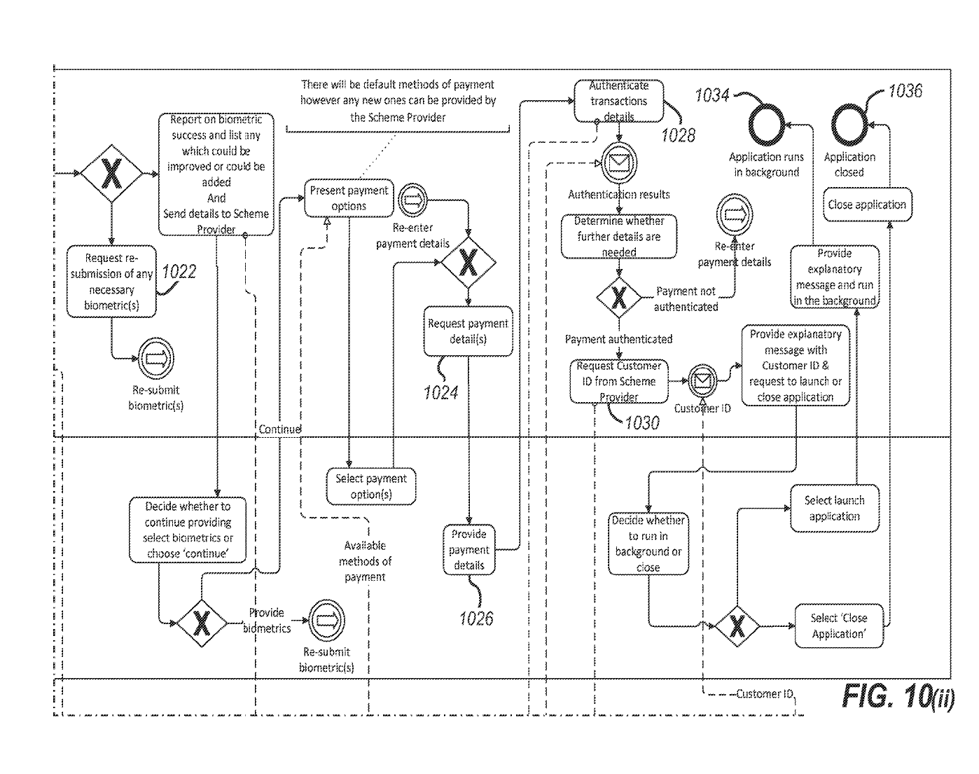

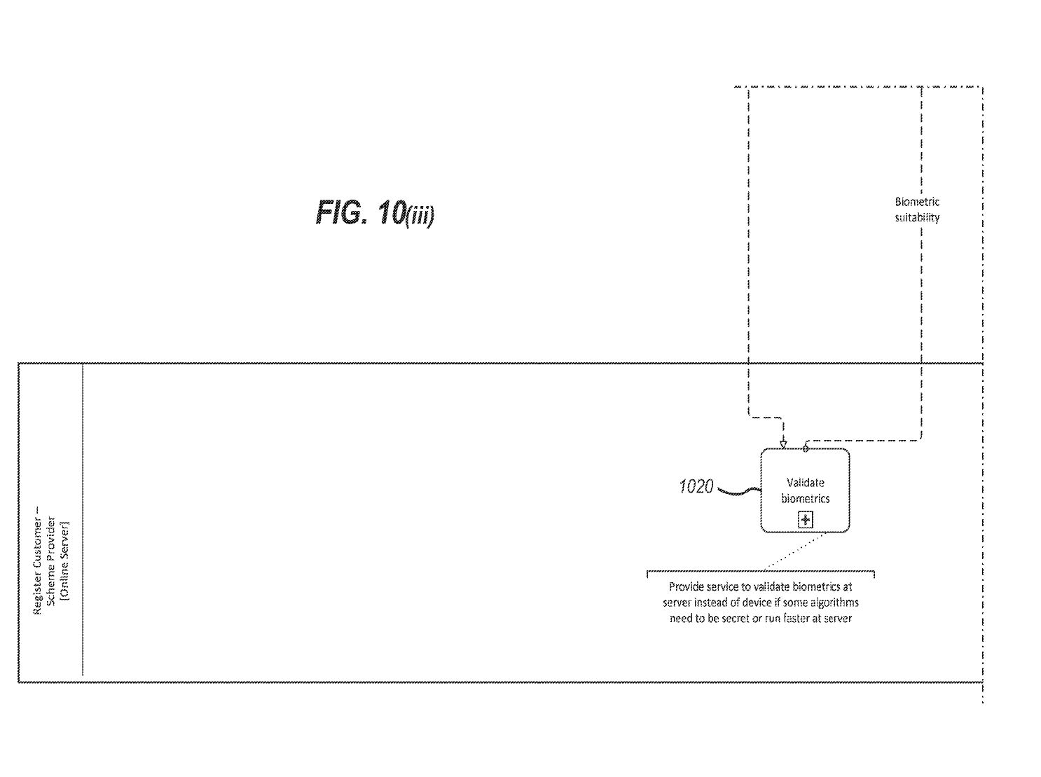

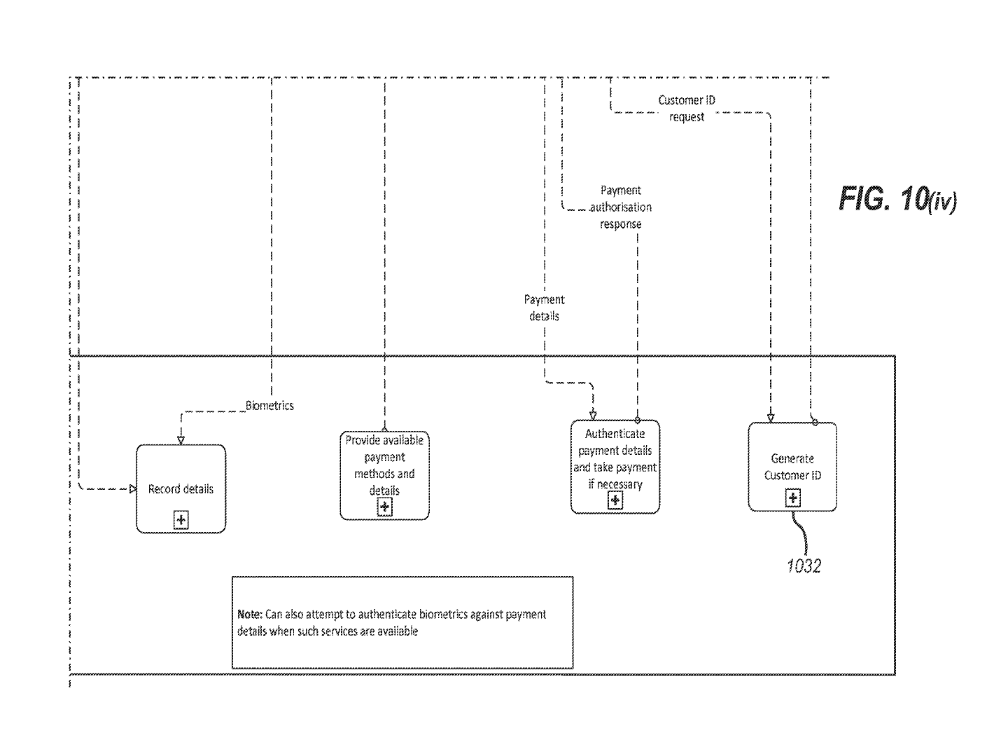

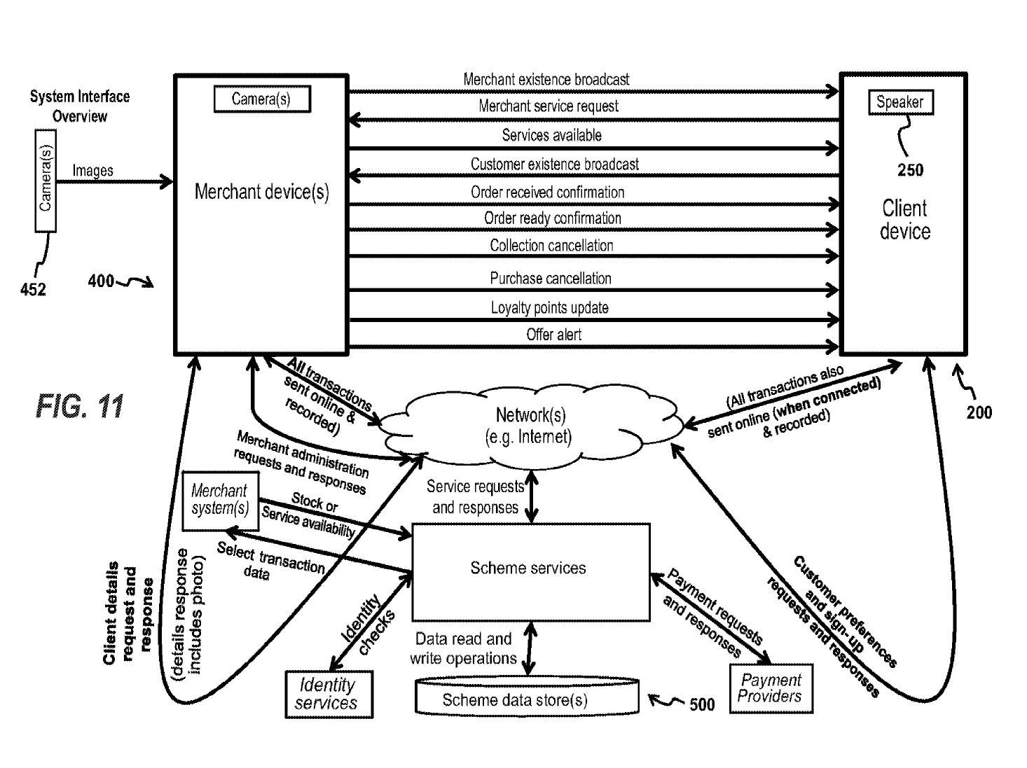

The aspects of the present invention will now be described in more detail with reference to the workflow diagrams of FIGS. 4 and 10.

### Location-Based Ordering

With reference to FIG. 4, workflow starts at 202 in which software such as an application is installed and configured to operate on the mobile device 200. The application may be downloaded from an application store and installed on an operating system of the mobile device.

Configuration of the acquirer application may involve the following. An acquirer may set up an account via the application. The account may be associated with the acquirer, and may be configured to access stored records of the acquirer's name, address, telephone number and payment details with which payment is to be made for products or services purchased using the system. The stored records may be stored in memory on either the mobile device 200, or the server 500. The account may be configured to access one or more photographs or other biometric information of the acquirer, for reasons explained further below.

Configuration of the acquirer application is shown in more detail in FIG. 10. The acquirer may download 1002 and install 1004 the acquirer application on his or her mobile device. At some point, the acquirer will chose to run the application 1006. The application will run 1008 on the mobile device and will request registration details 1010. These may include, name contact details and customer preference information, although this could be provided later. Once provided, 1012, the application may store the registration details (either on the memory of the mobile device or on the memory of the server) and request biometric identifiers 1014. These identifiers may be provided by taking a photograph using a camera on the mobile device, or by recording speech using a microphone on the mobile device. The biometric identifiers may be validated by the mobile device 1018 and/or the server 1020 and resubmitted if necessary 1022.

Once the biometric details have been provided, the application may store the biometric details (either on the memory of the mobile device or on the memory of the server) and request payment details 1024. Once provided 1026, the payment details may be authenticated 1028 and stored (either on the memory of the mobile device or on the memory of the server).

The application may request a Customer ID 1030, which may be used subsequently in the identification and authentication aspects of the invention, as discussed in more detail below. A customer ID may be provided by the server 1032, or generated by the application on the mobile device and sent to the server. The application may then run in the background 1034 or be closed 1036.

Returning to FIG. 4, the account may be associated with customer preference information 204. The customer preference information may contain one or more products or services preferred by the acquirer. These may be products or services which may be purchases regularly, on an ad hoc basis, or once. Along with a list of preferred products or services, the customer preference information may contain one or more suppliers of products or services preferred by the acquirer for purchasing one or more products or services. To facilitate selection of one or more products or services, the system may provide the mobile device with access to a database of products and services offered by each supplier to enable the acquirer 100 to select one or more preferred products or services. The database may be stored on the server 500 or the base station 400 but is accessible to the mobile device 200. The database may also be stored on the mobile device 200, for example in a cache memory, to enable an acquirer to have access to it without a network connection. In this case, the database may be updated based on the database may be stored on the server 500 or the base station 400. Moreover, the customer preference information may contain one or more geographical regions and/or one or more periods of time within which an order for one or more products or services may be placed. The periods of time within which an order may be placed may include a date on which location-based ordering commences, a date on which location based ordering ceases, specific times of the day, defined by a start and an end time, during which location-based ordering may take place and/or specific days of the week on which location-based ordering may take place. The customer preference information may also define a maximum number of repeat orders that may be placed by location-based ordering.

Likewise each of a plurality of product or service providers (suppliers) 400 will install and configure software such as an app on their base station. Alternatively, a base station comprising pre-installed software may be provided to the supplier.

Configuration of the supplier application may involve the following. A supplier may register themselves 402 as a supplier of goods and services from which acquirers may purchase goods via the applications installed on their mobile devices. Registration may be processed by the server 502. In registering, the supplier may provide information including the supplier's name, address, telephone number and bank account details to which payment is to be made for products or services purchased using the system. The supplier may also provide information including a list of products or services offered for sale using the system, together with product or service information such as a description, photograph or price. The information may be stored such that it is accessible to the acquirers, in memory on either the base station 400 or the server 500, for instance.

At some point in time during his or her day, the acquirer 100 will begin a journey 102, such as a commute to work, and will travel towards 104 a supplier. Preferably, the acquirer will have configured the customer preference information 204 such that the journey 102 will be towards one or more of the suppliers specified in the customer preference information 204, and at a time of day falling with the one or more periods of time specified in the customer preference information 204.

The location of the acquirer may be determined, either continuously or at various intervals. The mobile device belonging to the acquirer could be detected when it is within a specific radius of the supplier. Optionally, this could be performed only if a software application was running on the mobile device. The radius could be a standard radius, or configured by the supplier or acquirer.

The location of the mobile device can be determined using various means and using various data sources. As a skilled person is aware, Bluetooth signal strength, WiFi signal strength or GPS coordinates may all be utilised to determine location information, which may thus either be measured directly by a base station or received by the base station (either directly from the mobile device or via a server) using a wireless protocol (such as Bluetooth or WiFi) or the internet. Accuracy (e.g. through triangulation) of a mobile device can also be performed using another Bluetooth device of known location, e.g. where there are no mobile base stations accessible.

During the journey, the acquirer 100 will reach a trigger location. How the trigger location is determined is described in more detail below. The arrival of the acquirer 100 at the trigger location will be sensed by the means for determining a location of the mobile device, be that a GPS or equivalent provided on the mobile device, or an alternative system described above provided on the base station or server. In a preferred embodiment, the arrival of the acquirer 100 at the trigger location will be sensed by a wireless terminal located at the supplier upon an attempt by the mobile device to connect to the wireless terminal.

Upon reaching the trigger location, the processor will make a first determination 208. Firstly, the processor will receive location information from the means for determining a location of the mobile device and will determine that the mobile device has reached the trigger location. The processor may also scrutinise the customer preference information and determine whether the current time (provided by a clock with which the processor is in communication, for example) falls within the one or more periods of time specified in the customer preference information.

If the (or both) determination(s) is positive, the processor will decide to cause the transmission subsystem to trigger or transmit an order. An order is made up of at least three pieces of information: the identity of the acquirer, the goods to be ordered and the supplier to which the order is to be sent. Each of these pieces of information may be provided in a variety of different ways, depending on the preferred implementation. For example, the pieces of information may be represented by an acquirer reference, a product or service reference and a supplier reference, respectively.

The compiled order may also include information pertaining to the location of the acquirer or the expected time of arrival of the acquirer at the supplier. This enables the acquirer to estimate or be informed of when the acquirer is due to arrive at the supplier. This is described in more detail below.

In the case where the order is stored in memory at the server and the processor and transmission subsystem are provided on the mobile device, the order may be triggered by the transmission subsystem. Upon receipt of the trigger, the order will be sent from the server to the base station. In the case where the order is stored in memory at the mobile device, and the processor and transmission subsystem are also provided on the mobile device; or in the case where the order is stored in memory at the server, and the processor and transmission subsystem are also provided on the server, the order may be transmitted by the transmission subsystem.

Thus, the system provides the facility to transmit or trigger an order based on the determined location of the mobile device. This is advantageous, because it enables an order to be placed automatically without a user having to make a conscious effort to remember to place the order. The order may be placed at an appropriate time (i.e. when the acquirer reaches the trigger location) without requiring the user to take any action other than travel towards the supplier. Once the order is placed, the acquirer simply continues to travel towards the supplier to obtain the goods which have been ordered.

At 210, the processor may determine the goods to be ordered and the supplier to which the order is to be sent and compiles an order. This determination may be made based on the customer preference information, previous order histories, the determined location, the time of day, the sensed mood of the acquirer and so on. Alternatively, the order may have been compiled previously and may be stored in the storage device either on the mobile device or the server.

The compiled order is then sent 212 from the mobile device 200 or the server 500 to the base station 400. Preferably the order is encrypted when it is sent to the base station 400.

The compiled order is received 402 at the base station 400, which may forward the order on to the server 500 where it is received 504 and stored 506 in an archive for future reference. In an advantageous embodiment, upon receipt of the compiled order, the base station 400 may check 408 its own stock records 406 or capacity information and makes a determination 410 on whether the supplier has the stock or capacity to provide the goods specified in the compiled order, and thereby fulfil the received order.

If the base station determines that it does not have sufficient stock or capacity to fulfil the received order, it will generate a message 412 indicating that the order cannot be fulfilled and will send the message 414 back to the mobile device where it is received 214. Conversely, if the base station determines that it does have sufficient stock or capacity to fulfil the received order, it will generate a message 416 indicating that the order can be fulfilled and will send the message 414 back to the mobile device where it is received 214.

Upon receipt 214 of a message from the base station indicative of whether the order can be fulfilled, the mobile device may either generate a confirmation message 216 that the order has been placed, or generate a message 218 that the order has not been placed. In the latter case, the message may include suggestions for alternative goods which the acquirer may wish to purchase, or alternative suppliers from which the ordered goods may be acquired. These suggestions may be based on stock or capacity information from one or more suppliers, and may be generated by the mobile device, the server or the base station depending on preferred implementation.

Periodically, the mobile device may transmit or trigger order status alerts 220. These alerts may, for example, provide updated information as to the location of the mobile device. The alerts may be sent to the base station to facilitate monitoring of the order, as described in more detail below.

Once the base station 400 has determined 410 that it has sufficient stock or capacity to fulfil the order and has sent a message to that effect to the mobile device, it will cause a visual representation of the order to be shown 418 on a display device coupled to the base station. It may also cause an audible and/or visual alert to be generated to inform the supplier 300 that an order has been received.

The visual representation of the record may include, at least, details of the goods being ordered (based on the product or service information in the compiled order) and details of the acquirer from whom the order originated (based on the acquirer information in the compiled order). In preferred embodiments, the visual representation of the order may also include a photograph of the acquirer, which may be obtained from the records stored in the memory of the mobile device or the server, for example.

If and when the base station receives an order status alert from the mobile device or server, it may update the visual representation of the order to keep the supplier informed of the status of the acquirer.

An order status alert may be an indication that the goods desired for purchase by the acquirer have changed; that is, that the acquirer no longer wishes to acquire the goods specified in the original triggered or transmitted order, and now wishes to acquire different goods. However, a change in the goods specified in the order may be prohibited by the supplier, either absolutely or depending on circumstances such as whether the order has already been fulfilled if there is only a short amount of time before the acquirer is due to arrive at the supplier. An indication of whether a supplier permits a change in the goods, and if so under what conditions, may be given in the information about the supplier stored on the server or at the base station and can be conveyed to the acquirer via the acquirer device.

Alternatively, or in addition, an order status alert may be an indication of a new location of the acquirer, or of a new expected time of arrival of the acquirer at the supplier. This information may be used by the supplier to estimate or be informed of when the acquirer is due to arrive at the supplier.

In a preferred embodiment, upon receipt of order, the supplier may specify a period of time in which the acquirer must arrive at the supplier to collect the ordered goods. This period of time may be sent to the acquirer with the message 414. The base station may then determine 420 whether the acquirer arrives within the specified period of time. If so, supplier proceeds to identify the acquirer 422 and process a transaction, as explained further below. If not, the base station may generate and send a service failure message 424 to the mobile and/or the server, and the process flow ends 426.

At this point it is convenient to describe how the aforementioned trigger location is determined. Preferably the system is configured to learn an acquirer's travel history to determine probable route and journey time and suppliers which the acquirer is likely to visit. Data pertaining to the acquirer's travel history may be stored as history data at the server.

Calculations may be carried out, either at the server or on the mobile device or base station, based on the determined location information of the acquirer, and the acquirer's history data. A particular implementation is as follows.

The first time a client uses the system, a route service is used and the estimated journey time and estimated time of arrival is determined based on the location information. A suitable routes service is Google Maps, although a skilled person understands that alternatives are also available. As well as location information, the speed and trajectory of the acquirer may be used to determine the preferred route.

The processor may calculate the estimated time of arrival until acquirer arrives at the supplier and display the time to the acquirer and/or supplier.

When acquirers arrive at the supplier and a transaction is made, the actual time taken is recorded in the supplier's journey history. This may be used to determine an average journey time along various points on that acquirer's journey.

Moreover, for a plurality of points on the acquirer journey, a remaining journey time can be calculated and recorded so that when an order is triggered in future from that point (or an average between those points), the remaining arrival time can be estimated and used by the processor supplier to determine the urgency of the order.

The frequency of journey point updates can be as often as the system hardware and memory will allow. Table 1 and Example 1 below show locations along a acquirer journey towards a supplier, and Table 2 and Example 2 below show an exemplary journey log.

TABLE 1

| | Location | Location | Location | Supplier |
|---|---|---|---|---|
| Location (coordinates): | A | B | C | location |
| Recorded time at | Time A | Time B | Time C | Time M |
| coordinates: | | | | |
| Remaining journey time: | tA | tB | tC | tM |
| (Calculated on arrival) | | | | |

Example 1

| | | | | |
|---|---|---|---|---|
| Recorded time at | 08:30 | 09:40 | 08:42 | 08:45 |
| coordinates: | | | | |
| Remaining journey time: | 15 | 5 | 2 | 0 |
| (Calculated on arrival) | | | | |

TABLE 2

| | | Remaining | |
|---|---|---|---|
| Location | Recorded time | journey time: | |
| (coordinates): | at coordinates: | (Calculated on arrival) | Record Type |
| Location A | Time A | tA | Journey |
| Location B | Time B | tB | Journey |
| Location C | Time C | tC | Journey |
| Supplier location | Time M | tM | Acquirer |
| | | | Validation |

Example 2

| | | | |
|---|---|---|---|
| Location A | 08:30 | 15 | Journey |
| Location B | 09:40 | 5 | Journey |
| Location C | 08:42 | 2 | Journey |
| Supplier location | 08:45 | 0 | Acquirer |
| | | | Validation |

This data may be collected as soon as a software application is installed on the mobile device. However, in order to calculate ‘Remaining journey time’, an order must be placed. Mobile devices can be set to continually record journey data in order to increase the accuracy of their journey times and therefore the ETAs.

If a acquirer is unexpectedly delayed on their journey, the system may automatically alert the supplier by determining a differential along the journey points exemplified above. This differential would be close to the order preparation time, previously set by the supplier on a per-product basis, so as to avoid spoilt fresh produce such as hot drinks. The acquirer may also have the facility to update the supplier as to their progress by adding an estimated delay time which would be communicated to the order record on the supplier, and therefore re-prioritise that order on the list of orders.

When a acquirer's location activity overlaps with the journeys recorded in the history data to a degree of reasonable accuracy (for example within a radius of fifteen meters across a real or interpolated point), the system can calculate an estimated remaining journey time for an order if the supplier is on that recorded route.

Accuracy of remaining journey time can further be increased by matching across more than one consecutive vector during the acquirer movement. If the acquirer direction matches part of a recorded journey, the remaining journey time can be calculated. As the acquirer gets closer to the supplier, the remaining journey time should become more accurate as the probability of them deviating from their route should decrease, especially if they know they have an order in progress (and if that order is for fresh produce).

It will be appreciated that the system may be configured to provide other useful features which are within the scope of the present invention.

For example, acquirers may designate one or more ‘Trusted Friends’. Such Friends may make orders as described above, and acquirers may then add their own orders to the order of the Trusted Friend. This results in one collecting acquirer (the Trusted Friend) but two payees, who may be automatically billed upon committing the advanced order.

Moreover, an alert may be sent to one or more acquirers if there is an active order by one or more Trusted Friends with a supplier that provides an item that the acquirer has made a preference for. The acquirer who receives the alert can choose whether to send their order or not to the Trusted Friend. When opting or agreeing to be a Trusted Friend, a ‘Trusted Friend Order Capacity’ may be specified. This Trusted Friend Order Capacity specifies the number of orders the Trusted Friend is willing to carry on behalf of others. This can optionally be given an upper-limit by the respective suppliers, for example based on a reasonable amount the average person would be able to carry of a particular product.

It will be appreciated that the system may facilitate the supplier sending offers directly to the acquirer, either when the acquirer is determined to be within a particular geographical region (such as within range of a supplier) or on an ad hoc basis. The acquirer may opt in or out of receiving such offers from one or more suppliers in the customer preference information.

It will also be appreciated that the processor may be configured to issue an alert to the acquirer, either when the acquirer is determined to be within a particular geographical region (such as within range of a supplier) or on an ad hoc basis.

It will also be appreciated that as acquirers use the invention to purchase goods or services, they may accrue ‘loyalty points’ with the suppliers with whom they transact. As with the payment processing, the collection of loyalty points may be done automatically without presenting a card or token, and is therefore particularly convenient. As with conventional schemes, the loyalty points could be exchanged for incentives (for instance, a free coffee after ten points). Such schemes can be configured by the supplier.

Loyalty schemes could be configured through an internet portal whereby the supplier will log-in with an administrator account and set-up various parameters such as the description and rules of their loyalty schemes. They could have as many as they wish and would specify such parameters as number of points for a specific reward, the expiry date and the location where the schemes are valid. These schemes would appear on the acquirer application when they choose to view loyalty schemes for that supplier.

Moreover, acquirers may be able to search for suppliers using various parameters such as by description, location, supplier name or active (or historical) loyalty scheme versus reward value. The definition of value can be determined by the ratio of reward value to points required to redeem that reward. E.g. ten points for a coffee worth £2 would be 10:2 (value of 5), whereas another agent may ask for twelve points therefore 12:2 (value of 6). The lowest ratio value would be listed first.

It will also be appreciated that the invention permits information to be collected about the habits of acquirers, including preferences (specified in the customer preference information) or location information. This information is valuable and can be used to create targeted offers or for profiling likely product associations. This will help to inform suppliers about what offers they may want to run in the future.

It will also be appreciated that acquirers can suggest additional order items to a supplier by submitting a request.

An acquirer could be charged for the goods ordered when the supplier has indicated that the acquirer has collected the goods or services.

Alternatively, the acquirer could be charged for the goods when the order is submitted. In that case it would be preferable to stipulate that the acquirer must collect an item within a predetermined period of time depending on the supplier settings and agreement made on-screen with acquirer when acquirer configures preferences.

Alternatively, the acquirers may opt to be billed only when the acquirer is within the supplier's outlet. In that case it would be preferable for the supplier to make the order only when the acquirer appears at the supplier's outlet. The supplier may charge different amounts for different types of order. For example, they may charge more for a “Ready Upon Arrival” order than an “Order on Arrival” order, because the Supplier may decide to prioritise the “Ready Upon Arrival” orders because those respective Acquirers are benefiting from not queuing.

Regular statements can be made available to the acquirers to download (or have automatically emailed if required) through the scheme website via acquirer online account, or on their device.

The transfer of funds for a purchase by an acquirer to a Supplier may occur upon the successful acknowledgement of an order by a supplier. In other words, the following conditions must be satisfied.
a. The Acquirer must have chosen to purchase the particular item(s).
b. The Supplier must have selected to fulfil them.

If a Supplier cannot fulfil an order (because it has run-out of stock) within the specified time, the Acquirer may receive an automated apology message and the Supplier will get a notification to their Administration in-box with the Order details (e.g. Customer ID, time, items requested, status). In that case, the Supplier could, at their discretion, offer tokens to compensate the Acquirer, and offer a written apology directly to the acquirer. Compensatory loyalty points can be awarded to the acquirer at the supplier's discretion.

Acquirers should not be permitted to create orders without sufficient funds on their scheme payment credit, or without an authorised payment method set-up in their account.

Acquirers could set-up their devices to prompt before ordering. A “Prompt Before Ordering” option can be set across all Suppliers or for specific Suppliers or specific outlets, depending on Acquirer preferences. In this case, the mobile device will ask them for confirmation before creating their pre-configured order. At this point, the Acquirer has the opportunity to amend the order before sending it, or to discard it completely.

Useful for Acquirers is that the scheme will store receipts for them automatically without the need for paper print-outs. These receipts can be obtained via their log-in on the site or via their mobile device.

### Identification of the Acquirer

It will be appreciated that certain suppliers in which the aforementioned system may be implemented can become very busy, with a large volume of acquirers (some of whom may be utilising the system, and some of whom may not) arriving together or within a very short space of time. This is particularly true of high throughput suppliers, such as coffee shops. There exists a problem, then, of being able to quickly and accurately associate an acquirer who arrives at the supplier with an order which has been previously received at the base station. Since the purpose of the present invention is to improve the convenience with which orders may be made and transactions may be processed, it would be highly unsatisfactory if the acquirer's shopping experience was hampered by a delay in associating the acquirer with his or her order. Thus, as described below, the system of FIG. 1 shows a system for identifying an acquirer who has arrived at the supplier, and associating that acquirer with his or her order.

Whilst the following system is particularly beneficial when used in conjunction with the location-based ordering system described above, and will be described with reference to that system, this need not necessarily be the case. Instead of associating an acquirer who has arrived at the supplier with a pre-existing order, the system could instead be used simply to identify the acquirer to the supplier by reference to a record containing information about the acquirer, so as to facilitate an order or transaction which the acquirer makes subsequent to his or her arrival.

For implementing this system, the base station or server should have access to recognition data about the acquirer stored in the memory at the server or the mobile device, or supplied with an order. The recognition data should be sufficient to determine, to a reasonable degree of certainty appropriate for a given implementation, whether a given acquirer matches the recognition data. For example, the recognition data may be biometric data, such as facial recognition data, or data pertaining to an acquirer's physical or vocal characteristics. The recognition data should be associated with a record of the acquirer stored at the base station or server, and preferably including at least an acquirer reference.

The system comprises an input device configured to capture an input signal. The input signal captured by the input device will have some association with the acquirer who has arrived at the supplier and will be used to determine a match between that acquirer and the aforementioned recognition data. For example, the input device could be a one more cameras 450, 452, for example distributed around the supplier's premises, and the input signal could be an image or video clip of the acquirer arriving at the supplier. In that case, the recognition data may be biometric data, in particular facial recognition data. The image or video will then be processed by performing an image (in particular, facial) recognition process on it, either by the base station 400 or by the server 500, to determine whether the image or video contains a match with the biometric data. Alternatively, the input device could be a microphone, and the input signal could be an audio recording of the acquirer's voice at the supplier. In that case, the recognition data may be biometric data, in particular pertaining to the acquirer's vocal characteristics. The audio recording will then be processed by performing an audio (in particular, vocal) recognition process on it, either by the base station 400 or by the server 500, to determine whether the recording contains a match with the biometric data.

The biometric (particularly facial recognition) data may be based on the one or more photographs provided by the acquirer, described above. To facilitate facial recognition, the photographs submitted by the acquirer should conform to a minimum standard which can be checked automatically (e.g. using a series of algorithms) and subject to a later validation. The minimum standards could be equivalent to the UK Borders Agency standards, or better.

Alternatively, the input device could be a microphone and the input signal could be an audio signal output by the mobile device in the possession of the acquirer. The audio signal may be outside the audible range of human hearing, e.g. ultrasonic. The audio signal that is output by the mobile device of the acquirer may be encoded to include information that uniquely identifies the acquirer. The signal received by the input device will then be processed by the base station 400 or by the server 500 to decode the signal to identify the acquirer.

In an alternative embodiment, the recognition data may be location data for the mobile device in possession of the acquirer. Location data may also be used to identify an acquirer because in most circumstances it is safe to assume that the location of the mobile device which transmitted or triggered the order, or with which an acquirer is otherwise known to be associated with, is an accurate representation of the location of the acquirer. In this sense, the recognition data may also be considered to be about the acquirer, even though it does not pertain to a physical characteristic or identity information of the acquirer. The location data may be determined and supplied by the mobile device, for example based on GPS signals, or else determined and supplied by the server, as described above.

In embodiment described in the preceding paragraph, the input device may be a wireless base station within or near the supplier, and the input signal may be an attempt by the mobile device to connect to the wireless base station or a response by the mobile device to an attempt by the wireless base station to connect to the mobile device. Because the wireless base station is local to the supplier, it can be determined that any communications between the wireless base station and the mobile device are indicative of the location of the mobile device; namely in the same location as the supplier. The accuracy of the determined location could be improved, for instance, by measuring signal strength between one or more of the wireless base stations and the mobile device. A comparison is then made, either by the base station or the server, between the location data about the mobile device (supplied by the mobile device itself or the server) and the location of the mobile device determined by virtue of a connection of the mobile device to a wireless base station local to the supplier to detect a match.

When the base station determines a match between an acquirer who arrives at the supplier and recognition data, it can be said that the acquirer has been identified. Once the base station has identified an acquirer 422 arriving at the supplier, it may determine whether or not an order from that acquirer has been received by comparing the acquirer reference associated with the matched recognition data and the acquirer reference contained in the order. In circumstance where the supplier does not receive orders in advance, this step is not performed.

If an order has been received from the identified acquirer, the base station 400 may draw the supplier's attention to it. For example, the base station may cause a visual representation of the order to appear on a display connected to the base station, or move to the top of a list of representations of orders shown on the display, or change its visual appearance by flashing, changing colour or size and so on. Of course, a skilled person would appreciate that the base station 400 may draw the supplier's attention to the order in many other ways, either utilising a display or another output device such as a speaker. In the latter case, a roaming supplier may have a headset containing an input device of the kind described above, together with an earphone. In that case, the base station may cause the earphone to vocalise a representation of the record, such as the acquirer's name and the goods ordered by the acquirer.

In implementations of this system which are not linked to a location-based ordering system of the kind described above, the process in the preceding paragraph may also be used to draw the supplier's attention to a record of the acquirer which is not an order. Such a record may include the acquirer's name, address, telephone number and/or payment details with which payment is to be made for products or services purchased from the supplier.

If the display is a touchscreen display, the acquirer may provide a ‘swipe’ across the display device by moving a digit from one side of the display to the other to indicate the recognised acquirer can collect their product or service. Once the facial recognition sub-system has identified the acquirer and selected them to be on the list, the ‘swipe’ can be used to send an RGID to the acquirer device (described in more detail below)

Alternatively, this gesture could be detected by a camera 450, 452 on the supplier device. This would allow the supplier device to be used without having to touch it, which is particularly beneficial in cases of food preparation whereby the transmission of microbes must be minimised.

Another preferred gesture is for the supplier to point to a face on the screen (in the finger-point hand-gesture) to select the candidate acquirer from an array of acquirer photos with active orders before swiping to denote the selection.

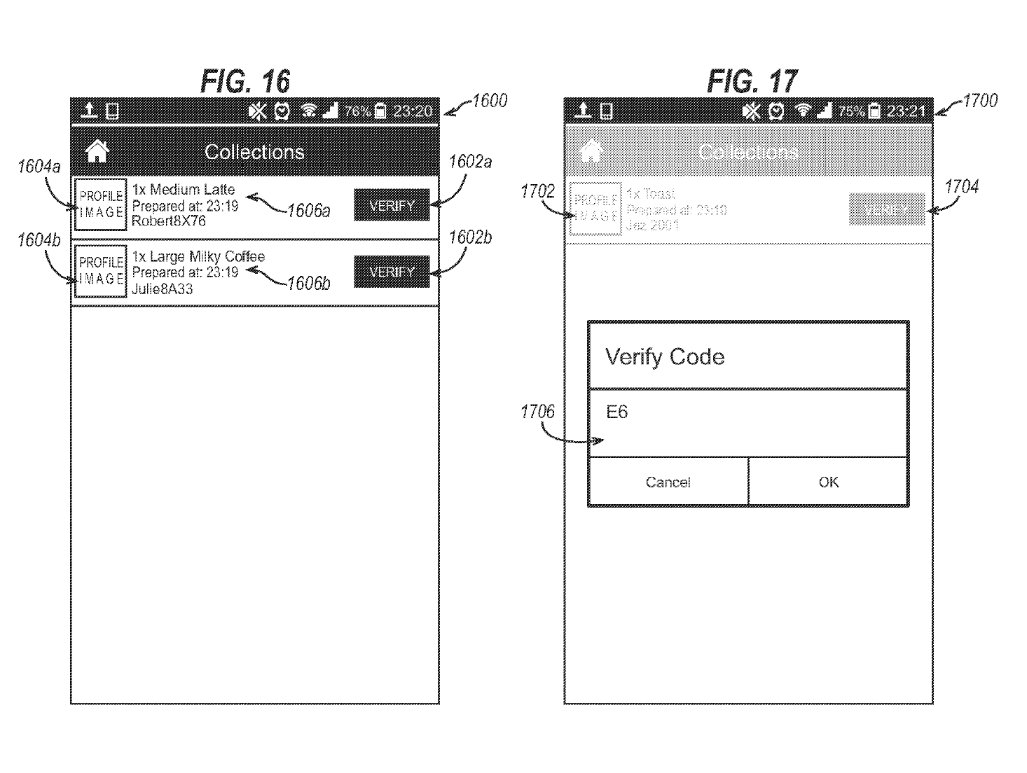

Examples of the display on a base station are given below in Tables 3 and 4 and depicted in FIG. 16. In Table 3, an example is given of an implementation in which orders have been received remotely, such as using the location-based ordering service described above. In Table 4, an example is given of an implementation in which orders have been not yet received.

TABLE 3

| | Customer | | Photo (click |
|---|---|---|---|
| ORDER | ID | Name | to zoom) |
| Medium Latte | Robert8X76 | Robert | [Photo of |
| with one sugar | | Own | Acquirer 1] |
| Large milky | Julie8A33 | Julia | [Photo of |
| coffee, no sugar | | Midori | Acquirer 2] |
| Search by Order | Search by | Search | Activate |
| | Customer ID | by name | photo search |

TABLE 4

| | | Standard | Standard | |
|---|---|---|---|---|
| Photo (click | Customer | purchase | purchase | Purchase |
| to zoom) | ID | combination 1 | combination 2 | entry |
| [Photo of | Robert8X76 | Medium Latte | Large Green | [Select to |
| Acquirer 1] | | with one sugar | tea, no sugar | specify |
| | | | | purchase] |
| [Photo of | Julie8A33 | Large milky | Double | [Select to |
| Acquirer 2] | | coffee, | espresso- | specify |
| | | no sugar | no sugar | purchase] |

| | | |
|---|---|---|
| [Text Entry area] | [Admin] | [Quick Undo] |

Thus, in a preferred embodiment, when an acquirer appears at a supplier, a member of staff of the supplier may determine whether the acquirer is listed on the order screen of the base station. This can be done by viewing the photos of acquirers who have placed orders and who are due to collect goods.

The base station speeds up this search and selection process by running a face detection algorithm based on input from a camera 450, 452. Face detection allows for the most obvious (closest or largest) face within its field of view to be selected and for the orders to be sorted and displayed on the base station

As face detection becomes accurate, the need for supplier intervention will decrease and, if the supplier device detects a high percentage match with an acquirer (e.g. 99% or 100%), all the supplier would need to do would be to confirm collection by selecting the order on the list.

It will be appreciated that a monitoring system may be provided to log transactions which took place with a low biometric match. These could be investigated or notification (for example by email) to the acquirer. If this happens on consecutive occasions, or a predetermined number of times, the acquirer's account may be suspended and need reactivating by the customer by them providing further security information (e.g. billing details).

It will be appreciated that the aforementioned system will facilitate collection of an order and/or processing of a transaction, removes the need for an acquirer to engage in a protracted negotiation with a supplier to collect an order or process a transaction, and vice versa.

### Authentication of the Acquirer

In certain suppliers in which one or both of the above-mentioned system operates the system for identifying an acquirer described above will be sufficient for authorising a transaction for the goods being ordered. This is particularly the case where the goods being ordered are low in value, such as in a coffee shop. In such circumstances, the level of certainty required that an acquirer who arrives at a supplier to collect an order is the acquirer who placed the order originally is lower than for goods of higher value.

However, in circumstances where the level of certainty must be high, or in cases where the system for identifying an acquirer is not sufficiently accurate, it is desirable to provide an additional measure to authenticate an acquirer before completing a transaction. This is beneficial in high throughput suppliers, such as coffee shops wherein many acquirers may have arrived together or within a very short space of time, and the merchant desires to be certain of processing the order of each acquirer correctly.

Whilst the following system is particularly beneficial when used in conjunction with the location-based ordering system and/or the system for identifying an acquirer described above, and will be described with reference to those systems, this need not necessarily be the case. The system may be provided as a stand-alone authentication system which may be used in a variety of circumstances which would occur to a skilled person.

To implement this system, the base station should be configured to process a plurality of pending orders. By ‘pending’ it is meant orders which have been received by the base station from one or more acquirers, but which have not yet been fulfilled; that is the goods have yet to be collected by the acquirer and a transaction has yet to be processed. Once the goods have been collected and/or a transaction has been processed, the order is deemed to have been fulfilled and is finalised. It then ceases to be ‘pending’.

A plurality of orders may coexist at the base station and as such it must be possible to determine between the plurality. To facilitate this, the base station may access, and in some implementations generate and attribute, an identifier with each order. The purpose of the identifier is to be capable of distinguishing between pending orders and the acquirers who have made them. Hence, although the identifier does not need to be unique, it should be distinct enough so as to ensure, to a reasonable degree of certainty appropriate for a given implementation, that no two acquirers who arrive at the same supplier within a given period of time will be associated with the same identifier.

To implement this system, the transmission subsystem, which may be provided either at the server or at the base station, should be configured to communicate with a mobile device of each of the acquirers utilising the system. This may be achieved, for example, by utilising the acquirer reference in the order, for example, which may be linked to contact details to facilitate communication between the transmission subsystem and the mobile device.

At an appropriate time, the base station may transmit, or trigger the transmission of, the identifier 426 associated with a pending order to the mobile device. The identifier will be received at the mobile device belonging to the acquirer who placed the order and may be given 222 to the merchant or base station in one of a variety of ways explained further below. The merchant or base station may then compare the identifier given by the acquirer with the identifier associated with pending order and, if the two match, the acquirer may be deemed authenticated in respect of that order.

If the system for authenticating an acquirer is being used with the system for identifying an acquirer described about, the base station may transmit, or trigger the transmission of, the identifier 426 to the acquirer upon identification of the acquirer. Alternatively, the base station may transmit, or trigger the transmission of, the identifier 426 to the acquirer upon selection of an order by the merchant. Alternatively, the base station may transmit, or trigger the transmission of, the identifier 426 receipt or detection of location information of the mobile device indicating that it is within a predetermined radius of the supplier, or base station.

The system for authenticating a user may rely on the merchant to compare the identifier given by the acquirer with the identifier associated with pending order and make a determination that the acquire is authenticated 302, or it may rely on the base station to perform the comparison and determination 428.

In the case where authentication is performed 302 by the merchant 300, the system should include a display to show a visual representation of the identifier to the merchant, together with the pending order with which it is associated.

The identifier may be an alphanumeric code, a password, identity details of the acquirer, the whole or part of the order, the cost of the order, the time of transmission of the order and the location of the order. The identifier may be displayed on the acquirer's mobile device, and then spoken by the acquirer, shown to the merchant or vocalised by the mobile device through a speaker 250. The merchant may then compare the spoken, shown or vocalised identifier with the visual representation on the display.

A preferred identifier is a customer “unique nick name”. This identifier may be included in the order and may also be used to mark products being sold (such as being written on a coffee cup). Nick names can be, for example, “Paul 10N2”, which is the acquirer's first name followed by a short code to make the name as individual as circumstances require, or unique. The nickname may be determined during the acquirer registration process.

In the case where authentication is performed 428 by the base station 400, the system should include an input device configured to capture an input from the acquirer or mobile device representative of the identifier received at the mobile device from the base station or server. In that case, the base station may be configured to process, or send for processing, the input captured by the input device to determine whether a match exists between the identifier sent to the mobile device by the base station, and the input captured by the input device.

For example, the input device could be a camera 450, 452, and the input could be an image or video clip displayed on the client's device. The image or video will then be processed by performing an image recognition process on it, either by the base station 400 or by the server 500, to determine whether the image or video received by the camera contains a match with the identifier sent to the acquirer. Alternatively, the input device could be a microphone, and the input could be one or more audio tones or an audio representation of the identifier. The audio recording will then be processed by performing an audio recognition process on it, either by the base station 400 or by the server 500, to determine whether the tones or audio representation received by the microphone contains a match with the identifier sent to the mobile device.

In an alternative embodiment, the input device may be a barcode or QR code scanner, and the input may be a barcode or a QR code displayed on the mobile device. The barcode or QR code will be processed by, either by the base station 400 or by the server 500, to determine whether the barcode or QR code received by the scanner contains a match with the identifier sent to the mobile device. This is particularly preferred in embodiments in which there is no human merchant, and the supplier is an unmanned suppler such as a vending machine.

Optionally, the input could also include a representation of the service provider of the system. This could be a brand name or other identifier associated with the service provider implementing the system on behalf of the supplier and acquirer. The representation could be a visual representation, or audio representation. For example, where the input is an audio representation of the identifier, the input could also include an audio representation of the brand name of the service provider. This would enable a base station 400 or a staff member to distinguish between two or more different authentication processes operating in the same premises, for example, and thus ignore inputs associated with a different authentication system.

In the event that no match between the identifier sent to the mobile device and the identifier shown by the acquirer, the merchant or base station may signal that no match has been found 304, 430 and the process flow may end.

In the event that a match is identified, the acquirer may be permitted 306 to collect the goods specified in the order with which the identifier is associated and/or process the transaction.

It will be appreciated that the aforementioned system will facilitate authentication of an acquirer to enable a supplier to ensure that an order and/or processing of a transaction is associated with the acquirer who placed the order. This removes the need for an acquirer to prove their identity to a merchant to collect an order or process a transaction, and reduces errors arising from an order being given to an incorrect acquirer.

As will be appreciated, the invention allows acquirers to collect goods by simply arriving at the supplier, and perhaps engaging a brief verbal dialogue with the merchant to enable a visual confirmation. The acquirer may then leave with their goods without a lengthy waiting time or without engaging in a protracted transaction.

The invention allows suppliers to prepare an order in advance of the acquirer physically appearing at the supplier's outlet. In a preferred implementation, the acquirer's order will appear on the screen of the supplier device when the acquirer is within range of the outlet, and the base station can provide an audible alert (such as the acquirer's name and their order).

For example, the order may be for a coffee and porridge, which the supplier may provide in a bag at a collection point with the acquirer's name on, ready and waiting for collection before the acquirer actually appears on the supplier outlet premises.

The acquirer can then present themselves at the collection point or base station, and the supplier can either identify the acquirer by matching their face with the order, and/or authenticate the acquirer by sending an identifier to the acquirer's mobile device which can be compared with the identifier associated with the order. Depending on the retail environment, the authorisation for collecting the goods or services can be performed either by the supplier or the acquirer (e.g. depending on the value of the goods).

Initial typical applications would work for low-cost goods (e.g. food for individuals or small groups) with minimal policing on the supplier side. If the supplier however has a good level of security to protect the goods or services until an acquirer is authorised to collect them, then suppliers and acquirers should also have confidence (or meet security requirements) to sell high-value goods using this Invention.

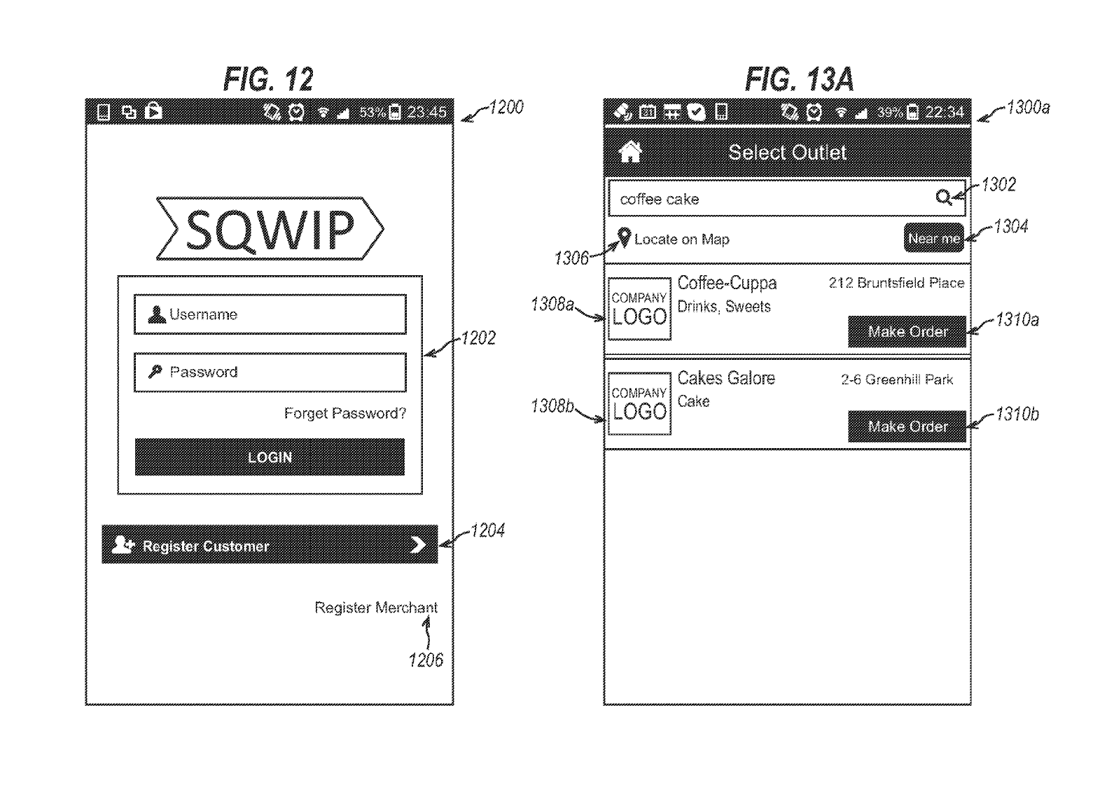

FIGS. 12 to 17 depict various display outputs of a supplier's or requester's device when operating a software application that is adapted to carry out an embodiment of the methods described herein.

FIG. 12 depicts a display output 1200 of a requester/supplier log in view. A requester/supplier that is already registered may log in by entering their username/password in field 1202. A new acquirer may register by selecting “register customer” option 1204. A new supplier may register by selecting “register merchant” option 1206.

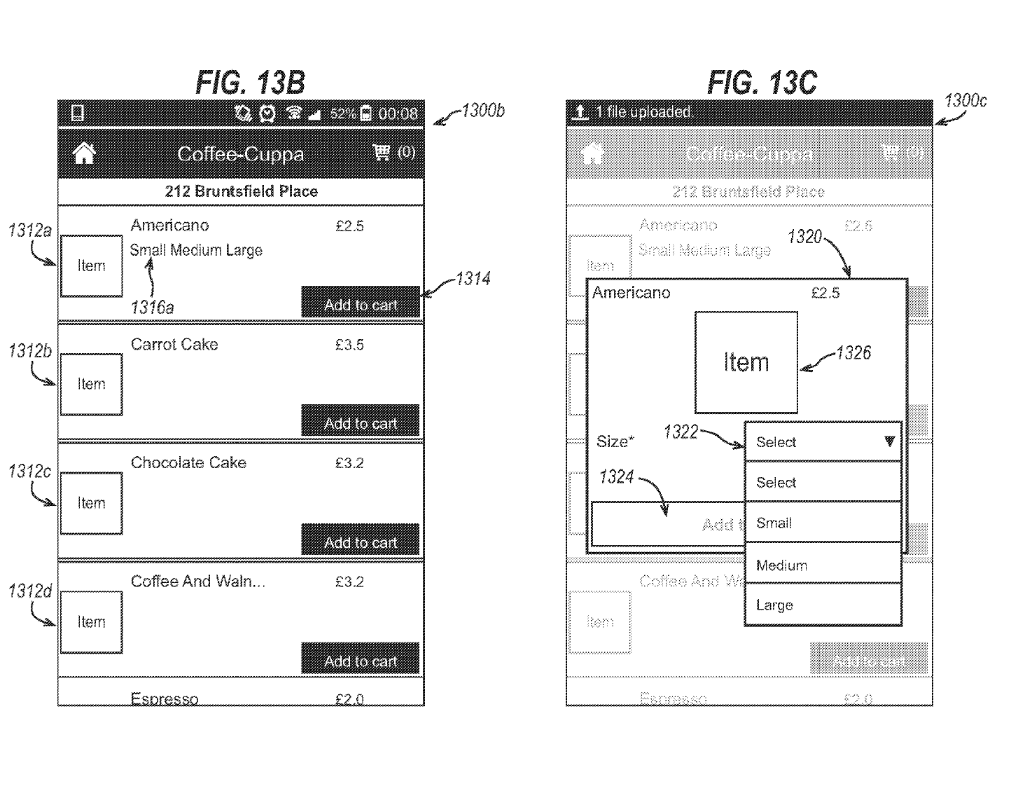

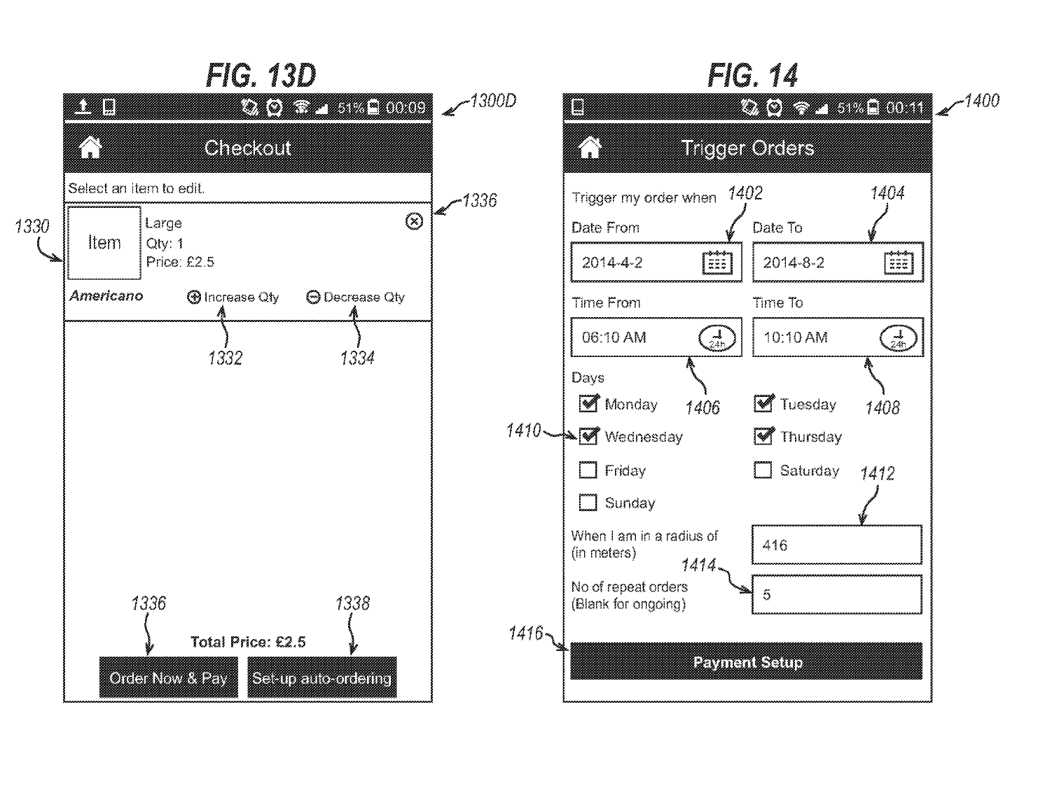

FIGS. 13A to 13D depict display outputs 1300a to 1300d of various views that an acquirer can use to order goods from a supplier. Display outputs 1300a to 1300d are displayed after an acquirer logs in, for example using the view depicted in FIG. 12.

FIG. 13A depicts a display out 1300a of a view that an acquirer may use to search for and select a supplier to order from. If the acquirer knows the name of the supplier that they would like to order goods from, or they know the type of good that they are looking for, they may search for suppliers using field 1302, which will cause suppliers matching the criteria that have been searched to be displayed. Alternatively, an acquirer may select “near me” option 1304, which will cause suppliers located in a geographical area around the location of the acquirer to be displayed. Also alternatively, the acquirer may selection “locate on map” option 1306, which will cause suppliers located around the acquirer to be displayed on a map. In the example depicted in FIG. 13A, an acquirer has searched for suppliers using the search field 1302. Suppliers 1308a and 1308b that match the criteria searched for are displayed. Each supplier 1308a and 1308b is presented with a “make order” option 1310a and 1310b. The suppliers 1308a and 1308b may be ordered on the screen according to distance to the acquirer, a search relevance score, or some other factor.

FIG. 13B depicts a display output 1300b of a view that an acquirer may use to select goods to order from a supplier. Various goods 1312a to 1312d that the acquirer may order are displayed. Each of the goods may be displayed with an “add to cart” option 1314, which the user may select to add the good to a virtual shopping basket. Goods may also be displayed with various options 1316 that may be applied to the goods on ordering (as shown in FIG. 13C). When more goods are available to be ordered than there is space in the display output to display them, the acquirer may scroll through the list of goods. The goods may be displayed in alphabetical order, ascending price order, descending price order, an arbitrary order set by the supplier or based on any other factor. The goods may optionally be sub-categorised for display and ordered within the sub-categories as described previously.

FIG. 13C depicts a display output 1300c of a view that an acquirer may use to select options on goods that they wish to order from a supplier. Display output 1300c may be displayed when an acquirer selects the “add to cart” option 1314 for goods with options 1316 as depicted in FIG. 13B. A dialog box 1320 is displayed. The dialog box 1320 may display an image 1326 of the goods, the price of the goods, a description of the goods, and/or any other information related to the goods. A drop-down box 1322 is displayed within dialog box 1320. The drop-down box 1322 provides options for the goods that the acquirer may select. The options do not need to be presented to the acquirer in a drop-down box and may be presented, for example, using radio buttons or any other suitable means. Once the acquirer has selected an option for the goods, they may select “add to cart” option 1324 to add the goods to a virtual shopping basket. If the acquirer selects the “add to cart” option 1324 without first selecting an option for the goods, for example from drop-down box 1322, an error message or prompt may be displayed.

FIG. 13D depicts a display output of a view displaying the virtual shopping basket that the acquirer may add goods to in a manner described with respect to FIGS. 13A to 13C. Goods 1330 that have been added to the virtual shopping basket are displayed. Each of the goods may have options that are selectable by the user to increase the quantity of the goods 1332, decrease the quantity of the goods 1334, or remove the goods from the virtual shopping basket 1336. The goods 1330 may be displayed with various characteristics such as the options that have been selected in a previous step described with respect to FIG. 13C, quantity information, price, an image of the goods, and/or any other information related to the goods. Once the acquirer has reviewed the contents of their virtual shopping basket and adjusted quantities etc., they may select the “order now and pay” option 1336 or the “set-up auto-ordering” option 1338. When the “order now and pay option” 1336 is selected, the selection of goods in the virtual shopping basket is sent to the supplier and the acquirer proceeds to pay for the goods. When the “set-up auto-ordering” option is selected, the acquirer is presented with a view that enables them to configure various options for an automatic order, as explained with respect to FIG. 14.

FIG. 14 depicts an example display output 1400 that an acquirer may use to configure an automatic or location-based order that forms part of the customer preference information. The location-based order may be configured by selecting a date for the location-based orders to commence 1402, a date for the location-based orders to cease 1404, a time of day during which a location-based order may be placed between time 1406 and time 1408, days of the week on which a location-based order should be placed 1410 and the radius around the supplier that, when entered, will trigger a location-based order if the other time and date criteria are met. The acquirer may also configure a maximum number of times 1414 that the location-based order may be automatically repeated. Customer preference information is described in more detail with respect to FIG. 4. Once the acquirer has input their preferences, they may select the “payment setup” option 1416 to configure payment for the location-based order and to finalise the preferences.

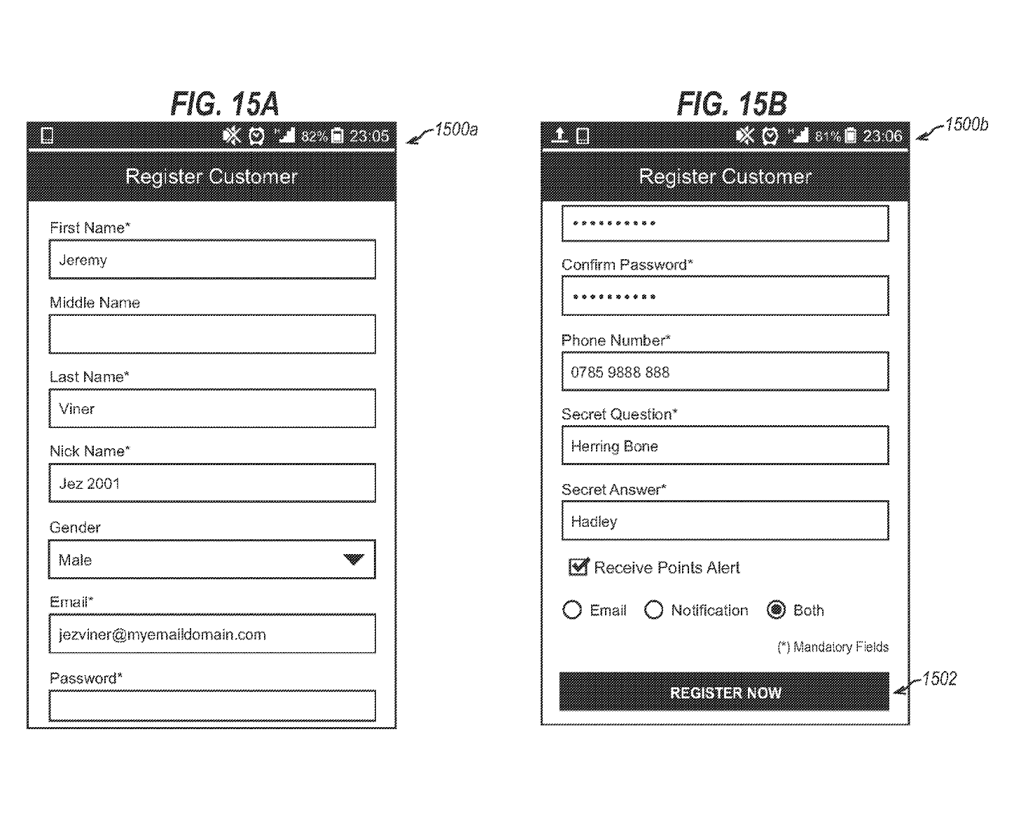

FIGS. 15A and 15B depict example display outputs 1500a and 1500b of a customer registration screen by which an acquirer can create an account and register with the service and to use with the application. The acquirer enters their first name, middle name, last name, a nick name or username, their gender, email address, password, password confirmation, telephone number, a secret question, and answer to the secret question and submits this information for registration by selecting the “register now” options 1502. It will be appreciated that other details relating to the acquirer such as those described with respect to FIG. 5 may be requested at the same stage or at a later stage.

FIG. 16 depicts an example display output 1600 in which orders have been received remotely. Orders 1602a and 1602b are displayed and may be selected to show further information. Associated with each order is an image 1604a or 1604b which is a photograph of the face of the acquirer. Order details 1606a and 1606b are also presented, displaying, example, the goods that have been ordered, the username of the acquirer and a time at which the order was prepared by the supplier. The order in which orders 1602a and 1602b are displayed on the screen may depend on the time at which the order was prepared, the proximity of the acquirer based on the location of the acquirer with respect to the supplier, or some other factor. When an acquirer arrives at the supplier to collect their goods, the supplier may select the “verify” button or option 1608a or 1608b on the relevant order.

FIG. 17 depicts another example display output 1700 that is displayed on a screen of the supplier. Display output 1700 may be displayed once the supplier has selected the “verify” button or option 1704 on an order. One or more orders 1302 are displayed (for example, 1602a and 1602b as depicted in FIG. 16) in a greyed-out manner on the screen. When the supplier selects this button, an identifier 1706 is displayed on the screen of the supplier. The identifier is sent by the base station 400 or server 500 to the acquirer's mobile device. When the acquirer's mobile device receives the identifier, it may audibly output the identifier using a speaker, so that the supplier can authenticate the acquirer, either manually or automatically as described above. Alternatively, the identifier may be displayed on a screen of the acquirer and the acquirer must show the identifier on the screen to the supplier in order to authenticate.

It will be appreciated that the invention has been described by way of examples, and that modifications to the examples given herein may be made without departing from the scope of the invention as defined in the appended claims.

1-39. (canceled)

40. A method for ordering a product or service from a product or service provider, utilising a mobile device, comprising:
storing customer preference information specifying one or more products or services;
determining a location of the mobile device; and
transmitting or triggering an order for one or more products or services specified in the customer preference information to a base station located at the product or service provider based upon the determined location of the mobile device.

41-60. (canceled)

61. A method of identifying an acquirer of a product or service from a product or service provider, comprising:
capturing an input signal with an input device;
accessing recognition data about a plurality of acquirers;
processing the input signal, or sending the signal to a remote device for processing, to determine whether the signal corresponds to recognition data about any one of the plurality of acquirers;
upon detection of a correspondence, accessing a record associated with the acquirer in respect of whom the correspondence was detected and outputting, on an output device, a representation of the record associated with the acquirer in respect of whom the correspondence was detected.

62-64. (canceled)

65. The method of claim 61, wherein the output device is a display device and the record comprises an image of the acquirer; and wherein the step of outputting a representation of the record comprises showing a visual representation of the record and showing the image together with the visual representation of the record.

66. (canceled)

67. The method of claim 65, wherein the step of outputting a representation of the record comprises showing visual representations of a plurality of records; and further comprising the step of, upon detection of a match, changing the visual representation of the record associated with the acquirer matched with the recognition data by one or more of: causing the record to flash, change colour or change size, and causing the record to move to a predefined area of the display, preferably the top of the display.

68. (canceled)

69. The method of claim 61, wherein the recognition data about the acquirer comprises location data relating to the location of a mobile device associated with the acquirer.

70. The method of claim 69, wherein the input signal is an attempt by a mobile device to connect to a wireless communication terminal, and wherein the step of processing the input signal comprises detecting the attempt to connect to the wireless communication terminal; and processing the location data to determine whether the mobile device is located within range of the wireless communication terminal.

71. The method claim 61, wherein the recognition data about the acquirer comprises biometric data and wherein the input signal is an image or series of moving images of the acquirer; and wherein the steps of processing the input signal, or sending the signal to a remote device for processing, comprise performing an image recognition process on the image or series of moving images, or sending the image or series of moving images to a remote device for performance of an image recognition process, respectively; and determining whether the image or series of moving images contains a match with the biometric data about the acquirer.

72-89. (canceled)

90. A method of authenticating an acquirer of a product or service from a product or service provider, comprising:
processing a plurality of pending orders for one or more products or services from a corresponding plurality of acquirers, each acquirer being associated with a mobile device;
accessing an identifier associated with each of the plurality of pending orders;
outputting, on an output device, a representation of at least some of the plurality of pending orders; and
transmitting the identifier associated with one pending order to the mobile device of the corresponding acquirer to enable the acquirer to be authenticated.

91. The method of claim 90, wherein the step of outputting comprises showing, on a display device, a visual representation of at least some of the plurality of pending orders by showing the identifier together with each of the orders, such that an identifier received by a mobile device may be compared with the identifiers shown on the display device.

92. (canceled)

93. The method of claim 91, further comprising the steps of: capturing an input; and either processing the input or sending the input to a remote device for processing, to determine whether the input matches an identifier.

94. The method of claim 93, wherein the step of capturing an input comprises capturing an image or series of moving images displayed on the mobile device using a camera; and wherein the step of processing the input comprises performing an image recognition process on the image or series of moving images, or the step of sending the input comprises sending the image or series of moving images to a remote device for performance of an image recognition process, to determine whether the image or series of moving images matches the identifier.

95. The method of claim 93, wherein the step of capturing an input comprises capturing a barcode or QR code displayed on the mobile device using a barcode or QR code reader; and wherein the step of processing the input comprises processing the barcode or QR code to determine whether the barcode or QR code matches the identifier.

96. The method of claim 93, wherein the step of capturing an input comprises capturing an audio signal spoken by the acquirer or emitted by the mobile device using a microphone, and wherein the step of processing the input comprises performing an audio recognition process on the audio signal, or the step of sending the input comprises sending the audio signal to a remote device for performance of an audio recognition process, to determine whether the audio signal matches the identifier.

97. The method of claim 91, further comprising the step of transmitting the identifier upon selection of one of the plurality of pending orders by the product or service provider.

98-100. (canceled)

101. The method of claim 40, wherein the step of transmitting or triggering an order for one or more products or services comprises determining the time from a clock; comparing the determined time with one or more periods of time specified in the customer preference information; and transmitting or triggering an order for one or more products or services only when the determined time is during the one or more periods of time.

102. The method of claim 40, wherein the step of transmitting or triggering an order for one or more products or services comprises comparing the determined location of the mobile device with one or more geographical regions specified in the customer preference information; and transmitting or triggering an order for one or more products or services only when the determined location is with the one or more geographical regions.

103. The method of claim 40, further comprising the step of determining a destination product or service provider from a plurality of product or service providers, by comparing the determined location of the mobile device with each of the plurality of product or service providers, and wherein the step of transmitting or triggering an order comprises transmitting or triggering the order to the destination product or service provider.

104. The method of claim 40, further comprising the step of calculating one or more of a target order transmission time, a target order fulfilment time and a destination product or service provider by utilising a route service that is configured to receive the locations of the mobile device and the product or service provider, determine at least one route between the mobile device and the product or service provider, and estimate the time required to complete the least one route.

105. The method of claim 40, further comprising the step of storing historical data pertaining to routes previously completed by the user, said historical data including one or more of selected routes, speed over the selected routes, trajectory during the selected routes, and time taken to complete the selected routes; and further comprising the step of determining one or more of the target transmission time, target fulfilment time and destination product or service provider based on the historical data and one or more of the determined location, current speed and current trajectory of the mobile device.

106. The method of claim 40, further comprising the step of creating a combined order by combining a first transmitted or triggered order with a second order for one or more products or services specified in the customer preference information; wherein the customer preference information specified in the first and second orders relates to different customers.
